(19) United States
(12) Patent Application Publication
(10) Pub. No.: US 2025/0300378 A1
(43) Pub. Date: Sep. 25, 2025

(54) CONTACT FOR A FLAT PLUG CONNECTOR AND FLAT PLUG CONNECTOR FOR A FLAT PLUG CONNECTOR SYSTEM

(71) Applicant: Yamaichi Electronics Deutschland GmbH, Aschheim (DE)

(72) Inventors: Alexander Ramonat, München (DE); David Ngan, Hallbergmoos (DE)

(21) Appl. No.: 19/086,534

(22) Filed: Mar. 21, 2025

(30) Foreign Application Priority Data
Mar. 22, 2024 (DE) 10 2024 202 735.9

(51) Int. Cl. H01R 12/77; H01R 13/41

(52) U.S. Cl. CPC H01R 12/771; H01R 13/41

(57) ABSTRACT

The present invention relates to a contact (70) for a flat plug connector (50), and a flat plug connector (50) for a flat plug connector system (1), wherein the flat plug connector (50) has at least one contact (70) according to the contact (70) for a flat plug connector, and
wherein the contact (70) has a terminal portion (71) for electrically conductive connection to an electronic component;
wherein the contact (70) has a retaining portion (73) for fixing in a plug connector housing (51);
wherein the contact (70) has a contact portion for electrically conductively contacting a complementary contact (34),
   wherein the contact portion is connected to the retaining portion (73) by means of a bent portion (74) of the contact (70),
   wherein the contact portion has a bent contact region (76) for electrically conductively contacting a complementary contact (34),
   wherein the contact portion has a first portion (75) which is arranged between the bent contact region (76) and the retaining portion (73), wherein the first portion (75) and the retaining portion (73) enclose an acute angle, and
   wherein the contact portion has a second portion (77) which is arranged opposite the first portion (75) relative to the bent contact region (76), and wherein the second portion (77) has a support portion (78) which is configured to be supported at the retaining portion (73) by the support portion (78) upon deflection of the contact portion towards the retaining portion (73).

The present invention relates to a contact for a flat plug connector and a plug connector for a flat plug connector system.

From the prior art, there are known various contacts and forms of contacts in plug connectors, such as, for example, flat plug connectors, to provide an electrically conductive connection to a conductor element of a complementary plug connector. Furthermore, it is known in particular to use gold-plated contacts, for example, to ensure good electrical conductivity of a plug connection in the long term.

It is therefore an object of the present invention to provide a contact for a flat plug connector as well as a flat plug connector having at least one contact, which enable a reliable electrically conductive connection.

In other words, it is in particular an object of the present invention to provide an improved contact for a flat plug connector for reliably electrically conductively contacting a complementary flat plug connector, as well as to provide a flat plug connector having at least one such contact.

This object is achieved by the independent patent claims. Specific embodiments result from the dependent patent claims.

One aspect of the invention relates to a contact for a flat plug connector,
wherein the contact has a terminal portion for electrically conductive connection to an electronic component, in particular a printed circuit board;
wherein the contact has a retaining portion for fixing in a plug connector housing;
wherein the contact has a contact portion for electrically conductively contacting a complementary contact,
   wherein the contact portion is connected to the retaining portion by means of a bent portion of the contact,
   wherein the contact portion has a bent contact region for electrically conductively contacting a complementary contact or conductor element,
   wherein the contact portion has a first portion which is arranged between the bent contact region and the retaining portion, wherein the first portion and the retaining portion enclose an acute angle, and
   wherein the contact portion has a second portion which is arranged opposite the first portion relative to the bent contact region, and wherein the second portion has a support portion which is configured to be supported at the retaining portion by the support portion upon deflection of the contact portion towards the retaining portion.

By the support portion supporting upon deflection of the contact portion, reliable provision of a predetermined and in particular substantially constant contact force can advantageously be ensured. As a result, in turn, an improved contact can be advantageously provided which reliably ensures electrically conductive contacting, in particular over a predetermined service life.

This also makes it possible, for example, for the contact to be non-gold-plated or in particular to have no gold. As a result, the contact, which makes reliable electrically conductive contact, is advantageously manufacturable inexpensively.

In exemplary embodiments, the terminal portion of the contact may extend substantially in the plugging direction, without being limited thereto. The plugging direction corresponds in particular to a plugging direction of the flat plug connector at which the contact is arrangeable in order to provide an electrically conductive contact by plugging it into a complementary flat plug connector for a flat plug connector system.

In other exemplary embodiments, the terminal portion may have an extension that does not substantially correspond to the plugging direction, but rather have an application-specific extension, in particular to connect the terminal portion in an electrically conductive and optionally also mechanical manner.

In exemplary embodiments, at least the terminal portion of the contact may be configured to be solderable, in particular reflow solderable.

The terminal portion is in particular configured to be or become electrically conductively connected to a printed circuit board and/or an electrical device or component. In exemplary embodiments, the terminal portion may additionally be configured to be or become mechanically connected to a printed circuit board and/or an electrical device or component, for example by means of soldering, screwing, clamping, crimping, and/or in another manner.

The terminal portion may in particular be arranged or formed at a first end of the contact. The support portion may in particular be arranged or formed at a second end of the contact.

The following portions may be arranged or formed at the contact, in particular in this order, starting from the terminal portion: retaining portion, bent portion, bent contact region, support portion.

The first portion may in particular be arranged or formed substantially between the bent portion and the bent contact region. The second portion may in particular be arranged or formed substantially between the bent contact region and the support portion.

The order shown above does not correspond to a specific spatial direction, but rather follows an extension direction of the contact.

The retaining portion may in particular be configured for form-fit and/or friction-fit and/or material-fit retention or fixing to or in the plug connector housing. For example, the retaining portion may have a contour, coating, surface, width and/or thickness which distinguishes it in particular from the contour, coating, surface, width and/or thickness of one or more adjacent portions and/or the entire remaining contact.

The retaining portion therefore advantageously enables reliable retention or fixing to or in the plug connector housing.

The retaining portion may in particular extend substantially in the longitudinal direction, wherein the longitudinal direction may be substantially parallel to a plugging direction of the flat plug connector to which the contact is fixable, and/or wherein the longitudinal direction may in particular be substantially parallel to a assembly direction of the contact, for fixing to the plug connector housing of the flat plug connector.

The contact is in particular configured to be elastically restorable. In particular, the contact portion of the contact may be configured to be elastically restorable.

The contact portion, and in particular the bent contact region thereof, may in particular be configured to be or become elastically restorably deflected upon electrically conductively contacting with a complementary contact or with a complementary conductor element.

This advantageously allows a substantially constant contact force to be ensured, in particular over a comparatively long service life of the contact, due to the elastically restoring force of the contact portion and additionally due to the support of the support portion at the retaining portion.

The contact force refers in particular to a force with which the contact portion presses against a complementary contact or against a complementary conductor element, in particular in a direction which is substantially perpendicular to the plugging direction. The contact force acts in particular in a direction which is substantially perpendicular to the contact area that forms between the contact portion and the complementary contact or conductor element. The contact force in particular describes a force substantially perpendicular to the plugging direction of the flat plug connector. The contact force may in particular be substantially parallel to a height direction described herein.

The bent contact region may in particular enclose a larger angle than the bent portion.

The bent contact region may in particular enclose a substantially obtuse angle, i.e. in particular an angle which is greater than 90°. The obtuse angle which the bent contact region encloses may in particular be arranged or formed on a side of the bent contact region facing the retaining portion. In particular, the obtuse angle which the bent contact region encloses may be arranged or formed on a lower side, in the height direction, of the bent contact region.

The bent contact region advantageously enables soft, or in other words gentle, contacting with a complementary conductor element. In particular, at least one of the bent contact region and the complementary conductor element may advantageously slide off the other in a restorable manner when they contact each other or come into contact with each other.

In particular, the contact is configured to come into contact with a complementary conductor element electrically conductively in a touching manner, in particular in a biasedly touching manner.

The touching of the complementary conductor element by the contact, in particular by means of a relative movement of the contact relative to the complementary conductor element, may in particular cause a deflection of the contact portion or the bent contact region thereof. The relative movement may in particular be substantially parallel to the plugging direction. When touching by means of the relative movement, in particular substantially in the plugging direction, at least one of the contact portion and the complementary conductor element may be configured to slide resiliently, in particular resiliently in an elastically restorable manner, off the other.

By virtue of the bent contact region, which is in particular elastically restorably arranged at the contact, low-damage electrically conductive contacting can therefore be advantageously ensured. At the same time, by virtue of the elastic restoring force, in particular in combination with the support by the support portion, a predetermined and in particular substantially constant contact force for electrically conductively contacting the contact or the bent contact region thereof can be ensured.

The bent portion may in particular be arranged or formed substantially between the bent contact region and the retaining portion of the contact.

The bent portion may in particular be arranged or formed at a foremost portion, in the plugging direction and/or in the assembly direction, of the contact.

Additionally or alternatively, the bent portion may be arranged or formed in particular at an end of the contact opposite the terminal portion in the longitudinal direction, in the assembly direction and/or in the plugging direction. Here, the bent portion in particular does not form a physical end of the contact. However, the terminal portion may form a physical end of the contact.

As a result, on the one hand, the contact is easily attachable to a printed circuit board and/or an electrical device. On the other hand, the contact is protectively receivable in a plug connector housing, while it ensures soft or, in other words, gentle contacting of a complementary conductor element, in particular by virtue of the restorable deflectability.

The acute angle of the bent portion may, in particular in an undeflected posture of the bent contact region or the contact portion, i.e. in an uncoupled state of the contact to a complementary conductor element, for example include an angle in the range from about 10° to about 30°, in particular an angle in the range from about 13° to about 27°.

The acute angle of the bent portion may, in particular in a deflected posture of the bent contact region or the contact portion, i.e. in a coupled state of the contact to a complementary conductor element, for example include an angle in the range from about 5° to about 25°, in particular an angle in the range from about 8° to about 22°.

Since the bent portion encloses an acute angle, soft or, in other words, gentle contacting with a complementary conductor element can be advantageously improved. Since the bent portion already has an acute angle in the undeflected posture, a further deflection reducing the acute angle advantageously has only a minor impact on the space required by the contact, namely due to the support of the support portion at the retaining portion opposite to the plugging direction.

Therefore, an improved contact is advantageously provided here which in particular allows to reliably ensure electrically conductive contacting, in particular over a predetermined service life.

In the following, various terms are used repeatedly, the understanding of which is to be facilitated by the following definitions.

The secured state of the flat plug connector system describes in particular a state in which the coupling portion and the complementary coupling portion or the flat plug connector and the complementary flat plug connector are not detachably coupled to each other, in particular are not detachably coupled to each other in a damage-free or non-destructive manner. In other words, the secured state is a state in which the flat plug connector and the complementary flat plug connector are non-detachably coupled to each other, in particular not detachably coupled to each other in a damage-free or non-destructive manner, without prior removal of the securing element from the securing position.

The unsecured state of the flat plug connector system, which is also described here as a non-secured state, describes in particular a state in which the coupling portion and the complementary coupling portion or the flat plug connector and the complementary flat plug connector are detachably coupled to each other, in particular are detachably coupled to each other in a damage-free or non-destructive manner, for example reversibly detachably coupled to each other.

The coupled state of the flat plug connector system describes in particular a state in which the coupling portion and the complementary coupling portion or the flat plug connector and the complementary flat plug connector are coupled to each other, in particular coupled to each other in a form-fit manner. In exemplary embodiments, the coupling portion and the complementary coupling portion or the flat plug connector and the complementary flat plug connector may additionally or alternatively be coupled to each other in a friction-fit and/or material-fit manner in the coupled state. In the coupled state of the flat plug connector system, the coupling portion and the complementary coupling portion or the flat plug connector and the complementary flat plug connector may touch each other (mutually), in particular at least in sections, in particular touch each other (mutually) with a bias.

In the coupled state, the flat plug connector and the complementary flat plug connector may in particular be electrically conductively connected to each other.

In the coupled state of the flat plug connector system, the flat plug connector system may in particular have the secured state or the unsecured state.

The decoupled state of the flat plug connector system, which is also described here as an uncoupled state, describes in particular a state in which the coupling portion and the complementary coupling portion or the flat plug connector and the complementary flat plug connector are not coupled to each other, in particular not coupled to each other in a form-fit manner. In exemplary embodiments, the coupling portion and the complementary coupling portion or the flat plug connector and the complementary flat plug connector may be coupled to each other neither in a form-fit nor friction-fit and/or material-fit manner in the decoupled state. In the decoupled state of the flat plug connector system, the coupling portion and the complementary coupling portion or the flat plug connector and the complementary flat plug connector in particular do not touch each other or touch each other without a (mutual) bias.

In the decoupled state of the flat plug connector system, the coupling portion and the complementary coupling portion or the flat plug connector and the complementary flat plug connector may alternatively or additionally be non-electrically conductively connected to each other.

In an exemplary decoupled state, the coupling portion and the complementary coupling portion or the flat plug connector and the complementary flat plug connector may be opposite each other or arranged opposite each other in the plugging direction.

Plugging direction: The plugging direction describes in particular a direction in which the coupling portion and the complementary coupling portion or the flat plug connector and the complementary flat plug connector are movable relative to each other to be transferred to the coupled state and/or to the decoupled state.

The plugging direction of the flat plug connector may be substantially parallel to the plugging direction of the complementary flat plug connector. The plugging direction of the flat plug connector may, additionally or alternatively, be a direction substantially opposite to the plugging direction of the complementary flat plug connector.

It is to be understood that the plugging direction may deviate from the plugging direction defined herein during assembly as long as it leads to a coupling, in particular a damage-free coupling, of the flat plug connector with the complementary flat plug connector.

Height direction or also thickness direction: The height direction, which is also described here as a thickness direction, describes in particular a direction in which the flat plug connector system or the flat plug connector, or the complementary flat plug connector, is usually described as flat. Here, the height direction or also thickness direction refers to the flat plug connector system or the flat plug connector, or the complementary flat plug connector, in a usual position of use of the flat plug connector system or the flat plug connector, or complementary flat plug connector.

The height direction or thickness direction may in particular be substantially perpendicular or perpendicular to the plugging direction. The position of use of the flat plug connector system, for example during assembly in a motor vehicle, may be in different spatial directions in relation to the vehicle, so that the height direction as used here does not have to correspond to a height direction of a vehicle.

Width direction: The width direction may in particular correspond to a main extension direction of the flat plug connector and/or the complementary flat plug connector. The width direction may in particular substantially correspond to a direction in which a plurality of contacts and/or conductor elements of the flat plug connector and/or of the complementary flat plug connector are arranged next to each other, in particular to come into electrically conductive contact with the contacts or conductor elements of the respective other one of the flat plug connector and of the complementary flat plug connector. The width direction may in particular be substantially perpendicular or perpendicular to the thickness direction.

Longitudinal direction: The longitudinal direction may in particular correspond to a main extension direction of a ribbon and/or a flexible printed circuit board which is connected to at least one of the flat plug connector and/or the complementary flat plug connector. It is to be understood that in a position of use, for example in a vehicle, the ribbon and/or the flexible printed circuit board does not have to have an even contour, but may, for example, be corrugated, stepped or run according to other conditions. In this respect, the longitudinal direction of the ribbon and/or the flexible printed circuit board may in particular correspond to a manufacturing state of the ribbon and/or the flexible printed circuit board, with a substantially longitudinal extension.

The longitudinal direction may in particular substantially correspond to a direction in which a plurality of contacts and/or conductor elements of the flat plug connector and/or the complementary flat plug connector extend at least in sections, in particular to come into electrically conductive contact with the contacts or conductor elements of the respective other one of the flat plug connector and the complementary flat plug connector. The longitudinal direction may be substantially parallel to the plugging direction. The longitudinal direction may in particular point substantially in the same direction as the plugging direction.

Furthermore, the longitudinal direction may in particular be substantially perpendicular or perpendicular to the thickness direction and/or the width direction.

The thickness or height direction, the width direction and the longitudinal direction may together form in particular a right-hand system.

The plugging direction may be substantially parallel to the longitudinal direction. Alternatively or additionally, the plugging direction may be substantially perpendicular to the width direction and/or to the height direction or thickness direction.

Ribbon: A ribbon as used here describes a multi-core cable in which the cores are arranged and/or guided substantially in parallel next to each other, in particular arranged and/or guided substantially next to each other in the width direction. The ribbon cable may have up to 96 cores, for example. The spacing between directly adjacent cores may, for example, be about 0.5 mm to about 2.54 mm, wherein the spacing between the cores does not have to be constant across the width of the ribbon, but may in particular be substantially constant.

Multi-core ribbon cables have the advantage that a large number of cores can be connected to a post plug connector, a soldering adapter or another plug connector with little effort using insulation displacement technology, instead of having to strip and then solder them individually. In particular, crosstalk of signals in the ribbon cable is advantageously lower than in a round cable and can be better controlled by the arrangement of the signals and the use of ground lines between critical signals.

The ribbon may, for example, have a shield such as an aluminum or copper foil wrapped around the ribbon, for example.

Flexible printed circuit board (FPC): Flexible printed circuit boards are flexible and in particular comparatively thin printed circuit boards. Flexible printed circuit boards may, for example, comprise or consist of conductor foils, and in particular comprise or consist of polyimide foils. Although assemblies constructed with these are more expensive, they enable high data transmission in a space-saving manner. However, flexible printed circuit boards usually have an increased manufacturing tolerance as compared to ribbon cables.

Both the ribbon and the flexible printed circuit board advantageously have a significantly smaller extension in the thickness direction than in the width direction and/or than in the longitudinal direction. In particular, the ribbon and/or the flexible printed circuit board may have an extension in the thickness direction that is approximately or at least an order of magnitude smaller than in the width direction and/or than in the longitudinal direction.

The ribbon and especially the flexible printed circuit board advantageously enable a space-saving arrangement and conduction of electrical signals in a motor vehicle, such as a car, for example, in particular for the conduction of high-frequency electrical signals to or from a multimedia unit of a motor vehicle, such as a car, for example.

If a direction or an angle is stated with the addition “substantially” or “approximately” or “about”, this addition means or should be understood to mean in particular a deviation from the relevant direction or the relevant angle in the range from 0° to 5°.

If a spatial dimension, a spatial ratio or any other ratio is stated with the addition “substantially” or “approximately” or “about”, this addition means or should be understood to mean in particular a deviation from the relevant dimension or the relevant ratio in the range from 0% to 10%.

In preferred embodiments of the contact, the support portion may limit the deflection of the contact portion such that a predetermined contact force is achieved.

In other words, the deflection of the contact portion or the bent contact region may be or become limited or restricted, for example by the support portion cooperating with the retaining portion, in particular such that a predetermined contact force is achieved.

For example, the support portion and the retaining portion may cooperate such that the support portion is supported at the retaining portion at a substantially predetermined support region or a substantially predetermined support position, with a deflection of the contact portion that is in particular elastically restorable.

By virtue of the predetermined support and preferably additionally by virtue of the elastic restoring force, in particular by virtue of the reduced angle which the bent portion has in the deflected posture, a substantially constant contact force, in particular provided or supported by two separate points, can be advantageously ensured.

The substantially constant contact force may in particular also be substantially constant for different deflections of the contact portion relative to the retaining portion.

This is made possible in particular by the acute angle of the bent portion, in particular in cooperation with the support portion supported at the retaining portion, which is in particular configured to limit a deflection.

In particular, the support portion and/or the retaining portion may have mutually complementary means which define a predetermined support position or a predetermined support position range to limit or restrict the deflection of the contact portion.

The mutually complementary means of the support portion and/or the retaining portion for defining a support position and/or a support range may comprise, for example, means influencing a frictional force, in particular means increasing a frictional force, one or more protrusions and/or recesses, in particular for mutual latching, and/or other means.

The means influencing and in particular increasing the frictional force may, for example, comprise coatings, in particular rubberized coatings.

The retaining portion may in particular have one or more protrusions and/or recesses, on a side facing the support portion, with which the support portion can engage or latch, for example, at least in sections.

In exemplary embodiments, the retaining portion may have one or more ramps at least in sections on a side facing the support portion. In other words, the retaining portion may, on a side facing the support portion, be formed in a saw-tooth shape, for example, in particular a saw-tooth shape such that, in sections, with increasing deflection of the contact portion towards the retaining portion, the support portion performs a movement opposite to the plugging direction and in particular upwards, i.e. a movement towards the complementary conductor element.

As a result, not only can the deflection be advantageously limited, but in particular a substantially constant contact force can be ensured even with increasing deflection.

In preferred embodiments of the contact, the predetermined contact force may be in the range from about 0.5 N to about 2.0 N, in particular in the range from about 0.8 N to about 1.6 N.

As a result, reliable electrically conductive contacting with a complementary contact or conductor element can advantageously be provided.

In preferred embodiments of the contact, the bent contact region may be exposed relative to the first portion and the second portion.

In other words, the contact portion may have a local maximum between the first portion and the second portion, wherein the bent contact region comprises the local maximum, in particular such that the bent contact region electrically conductively contacts a complementary conductor element in a position of use of the contact.

In still other words, in a position of use of the contact for electrically conductively contacting a complementary conductor element, the bent contact region may project relative to the first and second portions, in particular in a direction which is substantially perpendicular to the plugging direction, longitudinal direction and/or assembly direction, for example in the height direction.

By virtue of the arrangement of the bent contact region, which is exposed in particular perpendicular to the plugging direction, longitudinal direction and/or assembly direction, i.e. in particular in the height direction, the bent contact region can be advantageously configured or predetermined as for physically and electrically conductively contacting with a complementary conductor element.

For example, the bent contact region or a portion of the contact adjacent to the bent contact region may have a stiffener.

As a result, the deflection of the contact portion or the bent contact region can be advantageously absorbed substantially by reducing the acute angle of the bent portion. At the same time, the service life of the bent contact region, and furthermore the service life of the contact, can advantageously be improved.

In preferred embodiments, a spacing between the support portion and the bent portion may be greater than a spacing between the bent contact region and the bent portion, in particular in the longitudinal direction and/or in the plugging direction of the flat plug connector system.

As a result, the contact force introduced at the bent contact region can be advantageously supported and dissipated in a distributed manner at the bent portion and the support portion. Furthermore, as a result, the service life of the contact can advantageously be improved.

In preferred embodiments of the contact, a ratio of a spacing between the support portion and the retaining portion relative to the spacing between the bent contact region and the retaining portion may be in the range from about 3% to about 40%, in particular in the range from about 4% to about 30%, further in particular in the range from about 5% to about 20%.

In exemplary embodiments of the contact, a spacing between the bent contact region and the retaining portion may be in the range from about 1.1 mm to about 2.0 mm, in particular in the range from about 1.3 mm to about 1.8 mm. The spacing refers in particular to the exposed position of the bent region, for example to a greatest spacing in the height direction. The spacing refers in particular to a non-deflected posture or to a non-deflected state of the contact.

Alternatively or additionally, a spacing between the support portion and the retaining portion may be in the range from about 0.03 mm to about 0.2 mm, in particular in the range from about 0.07 mm to about 0.14 mm, for example about 0.1 mm. The spacing refers in particular to the position of the support portion most closely facing the retaining portion, for example to a smallest spacing in the height direction. The spacing refers in particular to a non-deflected posture or to a non-deflected state of the contact.

The spacings and ratios described advantageously allow to ensure suitable and reliable support or cushioning by the support portion, while at the same time the contact can be advantageously configured with a low overall height. As a result, the contact is further advantageously suitable for a particularly flat flat plug connector.

In preferred embodiments of the contact, the contact may comprise a thickness build-up portion between the terminal portion and the retaining portion, wherein the thickness build-up portion may extend such that the terminal portion and the retaining portion are spaced apart in a direction substantially perpendicular to the plugging direction, longitudinal direction, and/or assembly direction of the flat plug connector.

In particular, the thickness build-up portion may extend such that the terminal portion is spaced apart from the retaining portion substantially in the height direction.

This advantageously allows the terminal portion to be attachable at a certain level in the height direction or perpendicular to the plugging direction, assembly direction and/or longitudinal direction. At the same time, the retaining portion and other portions of the contact may advantageously be protectively received in the plug connector housing of the flat plug connector. Here, the contact may in particular be delimited from below by a lower wall of the plug connector housing of the flat plug connector.

In exemplary embodiments, the thickness build-up portion may have such an extension that the lower wall of the plug connector housing of the flat plug connector, in a coupled state of the flat plug connector, is delimited downwards in the height direction by a lower wall of a plug connector housing of a complementary flat plug connector.

The thickness build-up portion therefore allows to ensure an application-specific connection of the contact. This also allows the contact to be protectively received in the plug connector housing of the flat plug connector before assembly. Furthermore, the contact is thereby also protected in particular during assembly or during coupling to a complementary flat plug connector.

Furthermore, the flat plug connector is advantageously couplable to a complementary flat plug connector, in particular without impairing the level to which the contact is connected. As a result, the assembly of the flat plug connector or the flat plug connector system formed therewith can advantageously be improved.

In particular, it is advantageously made possible that, on the one hand, the contact or a plurality of contacts arranged next to each other are arrangeable in the plug connector housing in a manner protected at least on both sides in the height direction. On the other hand, a conductor element complementary to the contact, or a plurality thereof, can be arranged in a plug connector housing of a complementary flat plug connector in a manner protected at least on both sides in the height direction.

Assembly or electrically conductive contacting, i.e. coupling of the flat plug connector to the complementary flat plug connector, may be carried out in particular such that, in the coupled state, an upper wall, protecting in the height direction, of the one of the flat plug connector and the complementary flat plug connector is arranged between upper and lower walls, protecting in the height direction, of the other one of the flat plug connector and the complementary flat plug connector, and a lower wall, protecting in the height direction, of the other one of the flat plug connector and the complementary flat plug connector is disposed between upper and lower walls, protecting in the height direction, of the one of the flat plug connector and the complementary flat plug connector.

In other words, the contact or a plurality of contacts, as well as a conductor element complementary to the contact or a plurality thereof, may be arrangeable in particular in a plug connector housing that is “U”-shaped at least in sections. Here, the legs of the “U” form upper and lower walls protecting in the height direction. The respective “U”-shaped plug connector housings may further be coupled to each other, in particular in the plugging direction, such that one leg of the “U” of the one of the two plug connector housings projects into the opening of the “U” of the other one of the two plug connector housings.

As a result, the contact is advantageously already protectable by its arrangement at the plug connector housing of the flat plug connector. In addition, the contact is also advantageously protected during assembly, and in particular also advantageously after assembly.

This also advantageously allows to ensure a reliable electrically conductive connection over a long service life, and in particular to safely protect the contact or a plurality of contacts during assembly, disassembly, transportation and in a coupled state.

In preferred embodiments of the contact, at least one of the first portion of the restorable contact portion and the second portion of the restorable contact portion may extend substantially rectilinearly; and/or
the restorable contact portion may have a kink between the first portion and the bent contact region, wherein the kink may enclose an obtuse angle in particular on a side which faces away from the retaining portion; and/or
the support portion of the second portion may have a bend.

The rectilinear extension of the first portion and/or the second portion advantageously enables direct force transmission towards the bent contact region. As a result, a sufficient contact force for an electrically conductive connection can be advantageously ensured, and the contact force is in particular advantageously precisely predeterminable.

In particular, the substantially rectilinear extension of the second portion, which is arranged or formed between the bent contact region and the support portion, enables advantageously direct support to ensure a sufficient, predetermined contact force.

The kink is arranged or formed in particular between the bent contact region and the bent portion. The kink may in particular enclose an obtuse angle. The obtuse angle may in particular be formed on an upper side, in the height direction, of the kink or the contact portion. In other words, the obtuse angle of the kink may in particular be formed on a side of the kink facing away from the retaining portion.

The kink may in particular be arranged or formed directly adjacent to the bent contact region.

The kink advantageously allows to stiffen the bent contact region. As a result, the deflection of the bent contact region towards the retaining portion can advantageously be absorbed in a predeterminable manner substantially by reducing the acute angle which the bent portion encloses.

If, during the deflection of the bent contact region towards the retaining portion, the support portion touches the retaining portion, the bent contact region is advantageously supported by two separate support points. As a result, a substantially constant contact force can advantageously be ensured over a long service life.

The bend of the support portion, in other words the configuration of the support portion as a bent support portion, advantageously enables low-wear but targeted cushioning at the retaining portion. Furthermore, this advantageously enables the provision of a substantially constant contact force over a long service life.

In preferred embodiments of the contact, the retaining portion may have one or more protrusions for friction-fit and/or form-fit retention of the contact to the plug connector housing.

For example, a contact receptacle of the plug connector housing of the flat plug connector may have a contour corresponding to the retaining portion to fix the retaining portion, in particular with the one or more protrusions, in the contact receptacle in a friction-fit and/or form-fit manner.

The one or more protrusions of the contact may be configured to engage the plug connector housing when assembling the contact in the assembly direction, and in particular to jam or wedge in the plug connector housing.

A contact receptacle of the plug connector housing is in particular limited in the width direction by a pair of opposite support walls. The contact receptacle therefore represents in particular a cavity formed at least in sections between two support walls.

The one or more protrusions of the retaining portion may in particular protrude from the contact substantially perpendicular to the assembly direction of the contact, in particular substantially in the width direction.

When assembling the contact to or in the plug connector housing, the retaining portion may advantageously jam with the plug connector housing.

Additionally or alternatively, the retaining portion may have a greater extension in the width direction than adjacent or remaining portions of the contact.

As a result, the retaining portion is fixable to the plug connector housing in a form-fit and/or friction-fit manner, particularly in the height direction, and in a form-fit and/or friction-fit manner in the assembly direction.

Furthermore, the contact is thereby advantageously fixable to the plug connector housing at a predetermined height or at a predetermined level in the height direction, whereby the contact force is advantageously predeterminable.

In preferred embodiments of the contact, the contact may be tinned at least in sections.

In other words, the contact may in particular have a tin coating. In particular, at least the bent contact region of the contact may be tinned.

In particular, the contact may be non-gold-plated or have no gold.

The tinned contact advantageously allows to manufacture a particularly conductive and corrosion-protected contact inexpensively, while at the same time ensuring a predetermined contact force.

In preferred embodiments of the contact, the contact may be shaped in one piece, and in particular be a bending part.

The contact is advantageously manufacturable in particular inexpensively and with repeat accuracy.

The contact may in particular be configured to lie substantially in one plane. In other words, at least the retaining portion, the bent portion, the contact portion and the support portion may be configured to lie substantially in a single plane. In further exemplary embodiments, the entire contact may in particular be configured to lie substantially in one plane.

The contact force of the contact is thereby advantageously precisely predeterminable. In particular, a substantially equal contact force can be ensured for each contact in the case of a plurality of contacts.

As a result, the contact is advantageously manufacturable simply and inexpensively, while at the same time a predetermined contact force can be ensured for reliable electrically conductive contacting with a complementary conductor element.

A further aspect of the present invention relates to a flat plug connector for a flat plug connector system,
wherein the flat plug connector comprises a plug connector housing, and
wherein at least one contact according to the aspect relating to the contact is arranged at the plug connector housing.

As a result, a flat-shaped plug connector can advantageously be provided. Furthermore, the flat plug connector is advantageously suitable for vehicles, in particular for use in motor vehicles, such as cars, for example, since the installation space or free space in particular is very limited in terms of height in this case. For example, the flat plug connector advantageously allows to assemble air channels, such as for the air conditioner, for example, above and/or below the flat plug connector system, while at the same time ensuring a predetermined connection security of the electrically conductive connection of the flat plug connector system.

Exemplary, preferred and alternative embodiments of the aspect relating to the contact, as well as their effects, may correspond in particular to those as explained with regard to the aspect relating to the flat plug connector, and vice versa.

In preferred embodiments of the flat plug connector, the plug connector housing may have a plurality of contact receptacles for a corresponding plurality of contacts,
wherein each contact receptacle may receive a retaining portion of a contact, and
wherein each contact receptacle may be configured to laterally guide a support portion of a contact and/or a contact portion of a contact, in particular on both sides.

The contact receptacle may receive a retaining portion of a contact in particular in a fixed manner. The fixing may, for example, comprise a form-fit and/or friction-fit fixing, in particular substantially in parallel to the assembly direction of the contact and/or substantially in parallel to the width direction. Alternatively or additionally, the fixing may comprise a material-fit fixing, for example by means of an adhesive.

The contact receptacle may in particular be limited at least in sections by two support walls adjacent in the width direction. In other words, two support walls may in particular delimit an intermediate contact receptacle. The support walls may advantageously support or laterally guide the support portion and/or the contact portion of a contact of the plurality of contacts, in particular during a deflection of the contact, for example when contacting with a complementary conductor element.

Two support walls which delimit a contact receptacle therebetween may have a spacing in the width direction, for example, in the range from about 0.2 mm to about 0.4 mm, in particular in the range from about 0.3 mm to about 0.35 mm.

The contact may, in particular aside from the retaining portion, have a width in the width direction in the range from about 0.24 mm to about 0.32 mm, for example of about 0.28 mm.

The contact receptacle may in particular have a width which is slightly greater than a width of the contact, in particular aside from the retaining portion of the contact.

As a result, the contact can be advantageously guided and supported in the contact receptacle, for example during a particularly compressive deflection of the contact. This, in turn, allows the contact force of each contact received in a contact receptacle to be advantageously predeterminable, in particular to be predeterminable with repeat accuracy over a plurality of contacting or coupling operations.

At a lower end, in the height direction, of the contact receptacle, the contact receptacle may have a groove for fixing the retaining portion of a contact of the plurality of contacts. In particular, the contact receptacle may have a groove complementary to the retaining portion, which may have a different dimension and/or contour, in particular in the width direction, than the remaining contact receptacle.

In preferred embodiments, the groove at the lower end of the contact receptacle in the assembly direction may in particular be tapered. In other words, the groove at the lower end of the contact receptacle may have a decreasing width following the assembly direction of the contact.

The contact receptacle and in particular the groove thereby enable simple assembly of a contact to the plug connector housing, assembly of a contact to the plug connector housing guided along the groove, and simple friction-fit and/or form-fit fixing of the retaining portion to the plug connector housing. In particular, the tapered contour of the groove at the lower end of the contact receptacle allows to ensure a predetermined pull-out force against detachment of the contact from the contact receptacle on the basis of an assembly force for inserting the retaining portion into the plug connector housing.

As a result, electrically conductive contacting with repeat accuracy can further advantageously be ensured.

In preferred embodiments of the flat plug connector, the plug connector housing, and in particular the contact receptacles thereof, may be shaped so as to surround the contact portion of the contact in a direction perpendicular to the plugging direction of the flat plug connector, in particular on both sides, and
in particular to additionally partially surround the contact portion, namely on a side facing a complementary flat plug connector in the plugging direction of the flat plug connector, i.e. at the front in the plugging direction.

The plug connector housing may in particular have an upper wall and/or a lower wall which surrounds the contact portion of the contact perpendicular to the plugging direction, and in particular in the height direction, in particular on both sides. The lower wall may in particular be formed or arranged directly adjacent to a lower end of the contact receptacles or directly adjacent to a lower end of the support walls. The lower wall may therefore in particular be configured to provide support of the retaining portion of a contact in the height direction.

At a front end, in the plugging direction, of the lower wall, the plug connector housing may in particular have a front wall.

The front wall has in particular an extension in the height direction which is smaller than an extension of the contact in the height direction. In other words, the front wall may in particular be configured to extend in the height direction at most as far as adjacent to the bent contact region. In still other words, the front wall may, in particular together with the upper wall, form an opening which is configured to allow insertion of an electrically conductive contactable conductor portion into the opening, in particular with an upper wall of a complementary flat plug connector abutting against it.

The front wall may in particular form a front end, in the plugging direction, of the support walls and in particular be configured to connect the support walls to each other in the width direction.

As a result, the contact can be advantageously protected, while at the same time contacting, that is in particular guided in a predetermined manner, with a complementary flat plug connector is enabled. In particular, the contact can be advantageously protected both before coupling to the complementary flat plug connector and during coupling to the complementary flat plug connector.

In preferred embodiments of the flat plug connector, a plurality of contacts may be arranged next to each other at the plug connector housing,
wherein the plurality of contacts may be divided into at least two groups,
wherein the contacts of a first group of contacts are substantially evenly spaced apart from one another, wherein the contacts of a second group of contacts are substantially evenly spaced apart from one another, and wherein the groups are spaced apart from one another by a distance spacing which is greater than the contact spacing of the first group and greater than the contact spacing of the second group.

The contact spacing is in particular a spacing between two directly adjacent contacts of a respective group. A contact spacing may be in the range from about 0.5 mm to about 1.0 mm, for example.

The distance spacing between two groups may be in the range from about 4 mm to about 10 mm, for example.

The distance spacing advantageously enables the arrangement of a coupling portion for coupling to a complementary coupling portion of the complementary flat plug connector between the groups of contacts. As a result, the flat plug connector can be advantageously be configured to be thin or flat. For example, the flat plug connector may have a height of less than about 8 mm, in particular less than about 7 mm, in particular less than about 6.5 mm, for example of about 6 mm.

As a result, the flat plug connector can advantageously be configured in a space-saving manner. Furthermore, by virtue of the distance spacing, in particular contact pairs with high potential differences can be separated from each other. Furthermore, as a result, a reliable, predetermined connection security of an electrically conductive connection can be advantageously ensured.

In the following, embodiments of the invention are described in more detail with reference to the appended figures. It is to be understood that the present invention is not limited to these embodiments, and that individual features of the embodiments can be combined to form further embodiments within the scope of the appended claims.

In the following, in particular the flat plug connector previously referred to as a flat plug connector may in particular be referred to as a complementary flat plug connector. Accordingly, the flat plug connector previously referred to as a complementary flat plug connector may in particular be referred to below as a flat plug connector.

### Shown are:

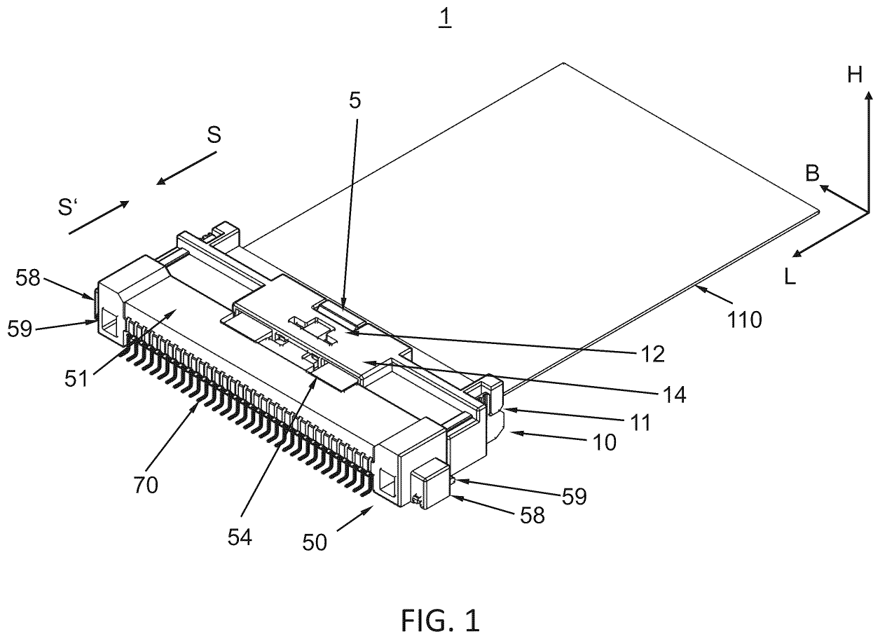

FIG. 1 an oblique view of a flat plug connector system, according to one embodiment of the present invention;

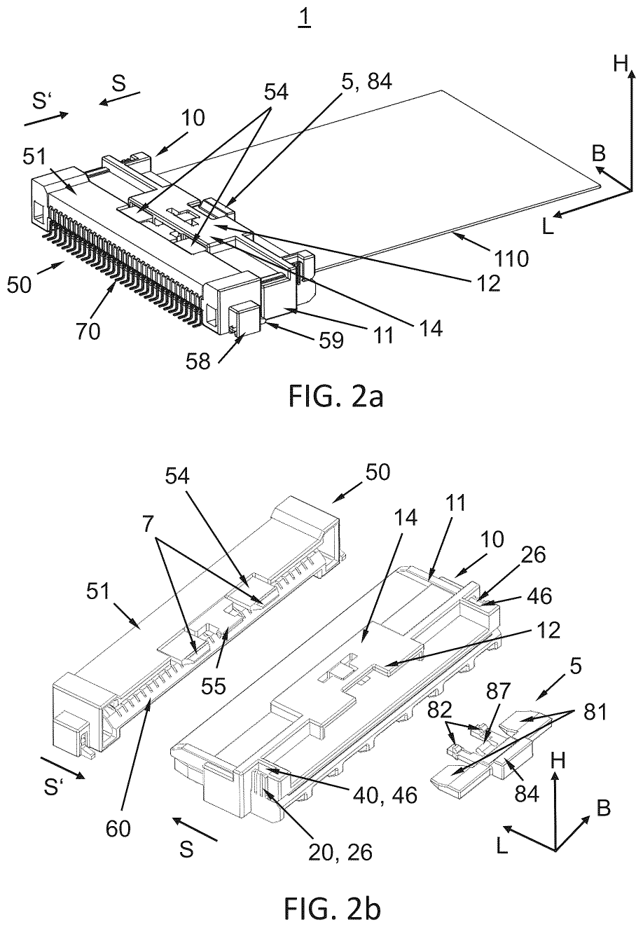

FIG. 2a an oblique view of a flat plug connector system, according to one embodiment of the present invention;

FIG. 2b an oblique view of a flat plug connector system, according to one embodiment of the present invention;

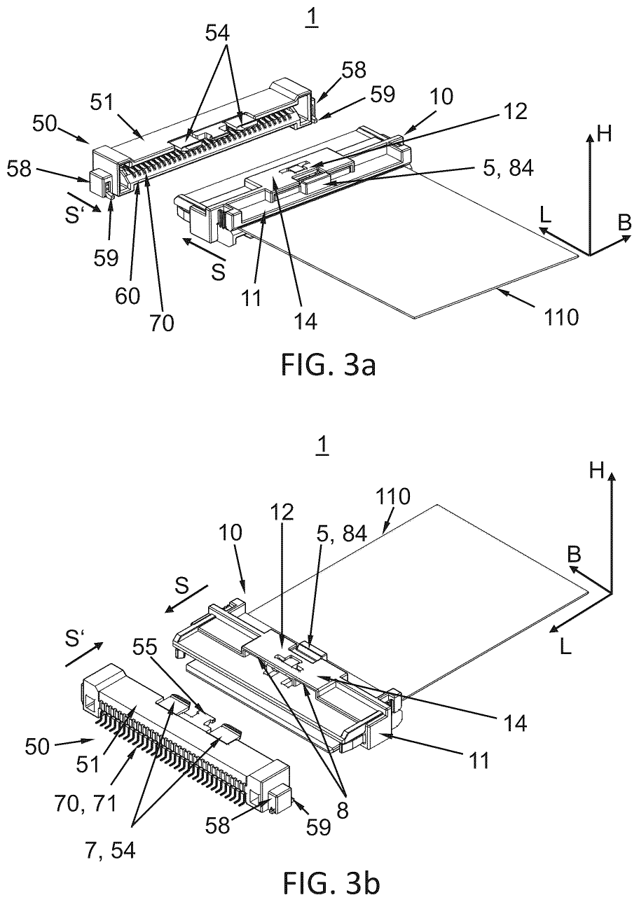

FIGS. 3a and 3b each an oblique view of a flat plug connector system, according to one embodiment of the present invention;

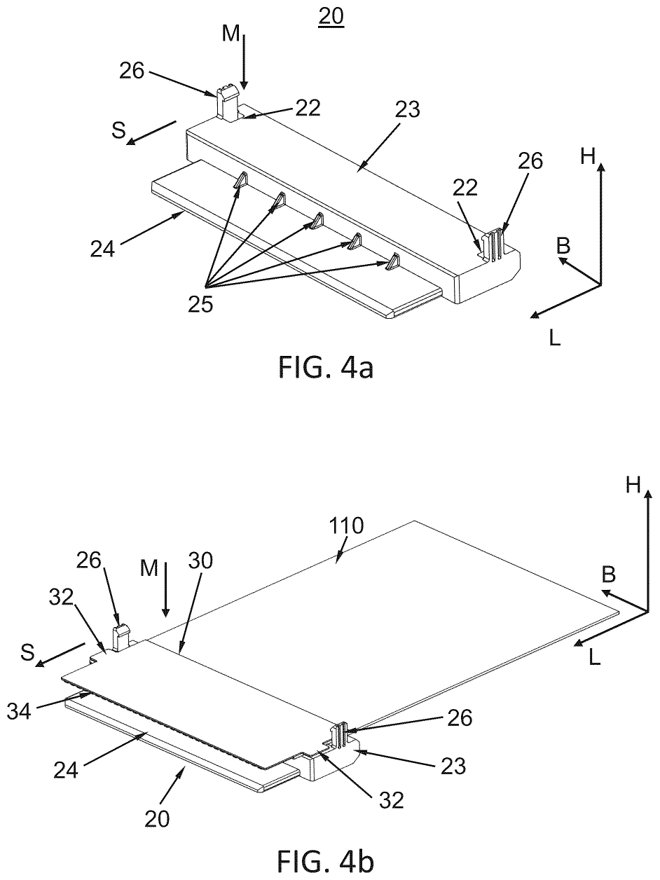

FIG. 4a an oblique view of a plug connector housing part, according to one embodiment of the present invention;

FIG. 4b an oblique view of a plug connector housing part of a flat plug connector with a conductor portion, according to one embodiment of the present invention;

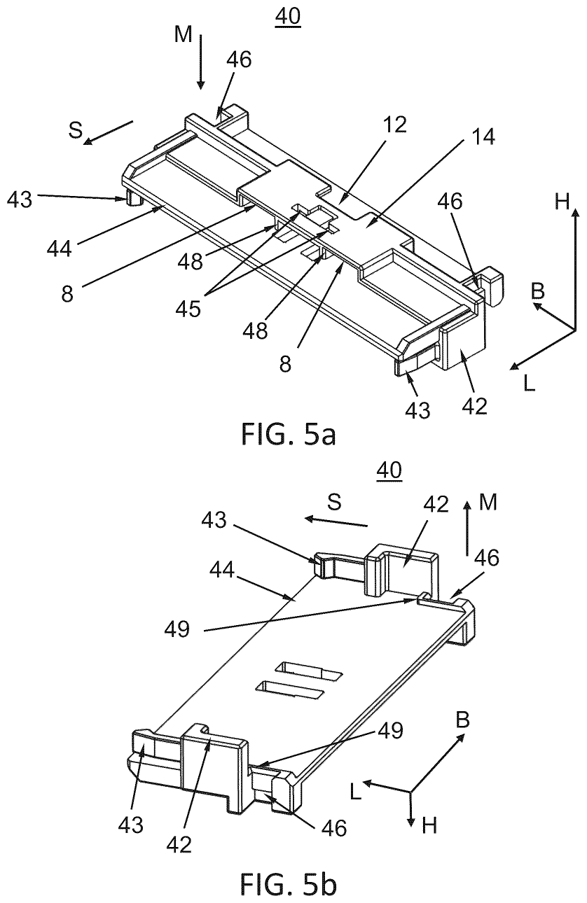

FIG. 5a an oblique view from above of a plug connector housing part of a flat plug connector, according to one embodiment of the present invention;

FIG. 5b an oblique view from below of a plug connector housing part of a flat plug connector, according to one embodiment of the present invention;

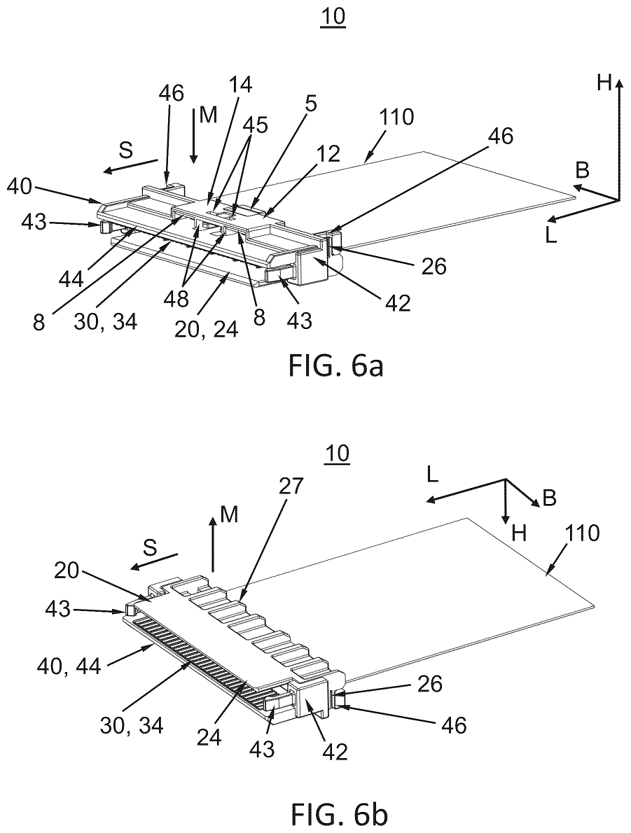

FIG. 6a an oblique view from above of a flat plug connector system, according to one embodiment of the present invention;

FIG. 6b an oblique view from below of a flat plug connector system, according to one embodiment of the present invention;

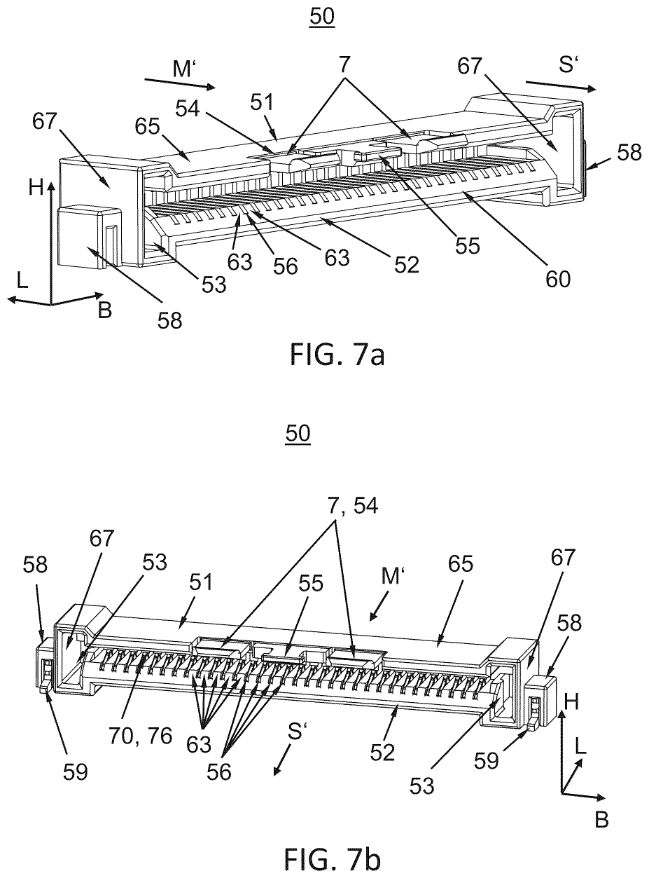

FIGS. 7a and 7b each an oblique view of a complementary flat plug connector, according to one embodiment of the present invention;

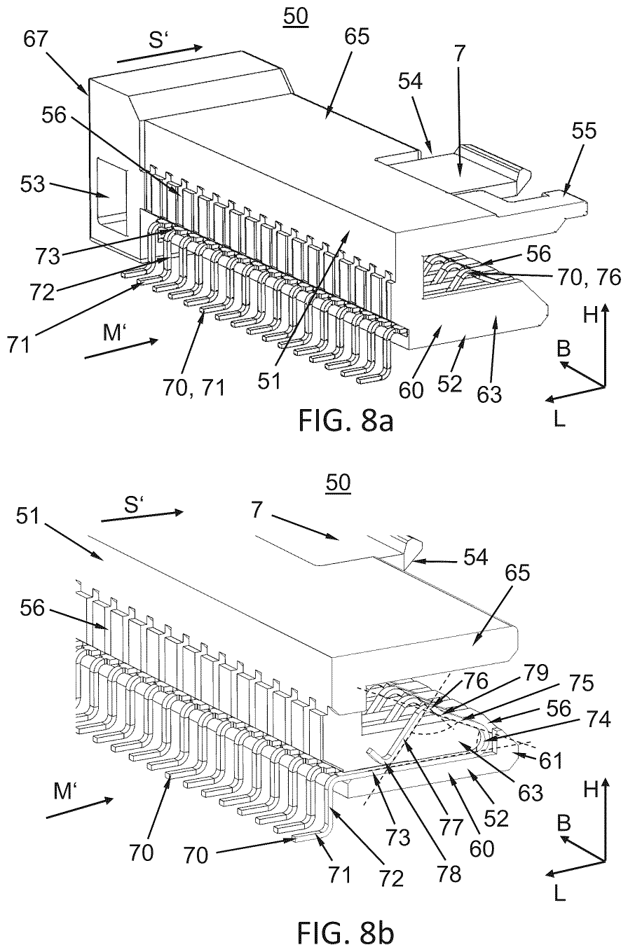

FIGS. 8a and 8b each a sectional illustration of a complementary flat plug connector, according to one embodiment of the present invention;

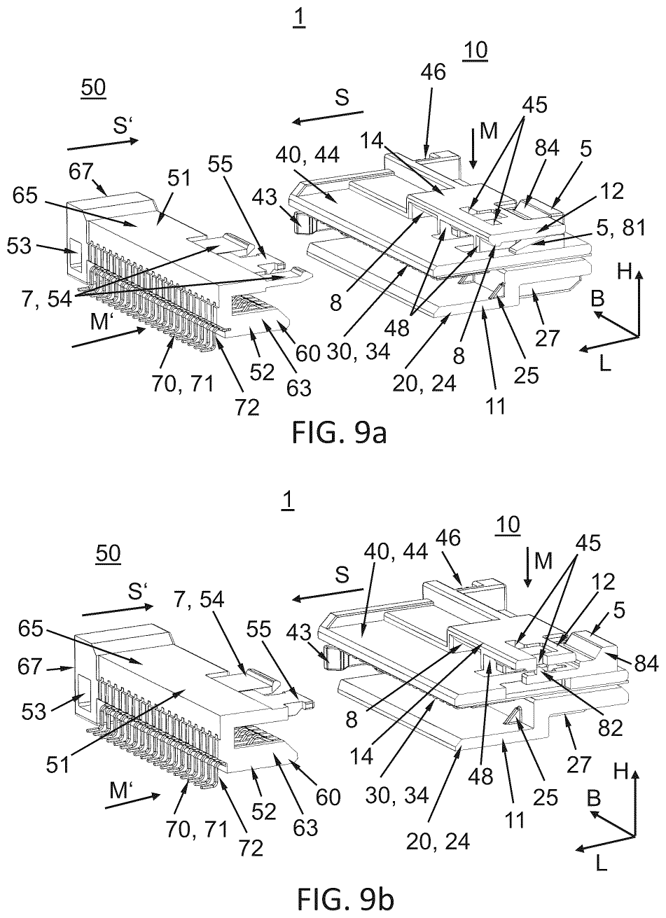

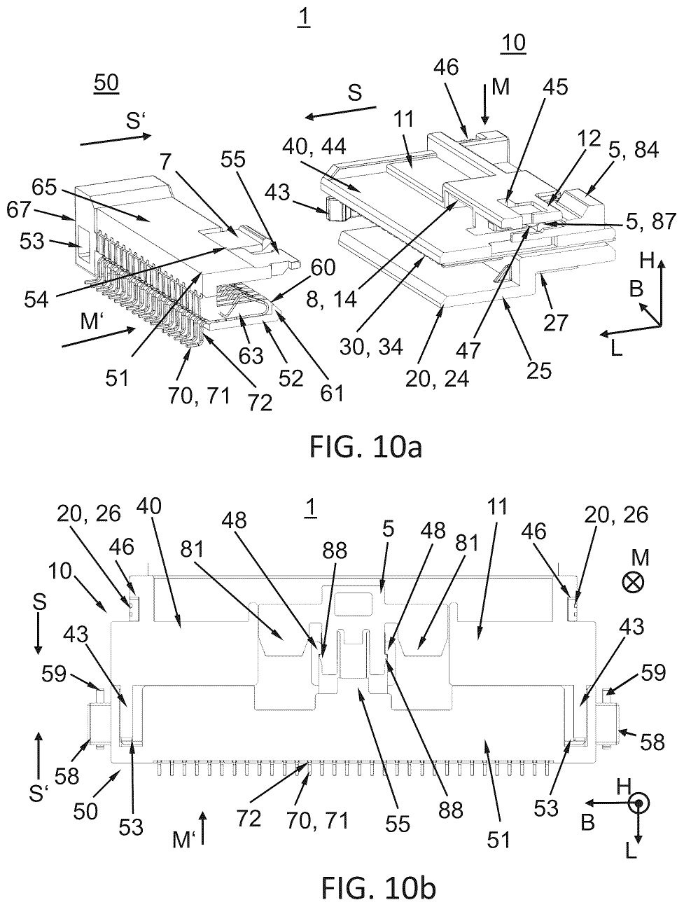

FIGS. 9a to 10a each a sectional illustration of a flat plug connector system, according to one embodiment of the present invention;

FIG. 10b a plan view of a sectional illustration of a flat plug connector system, according to one embodiment of the present invention;

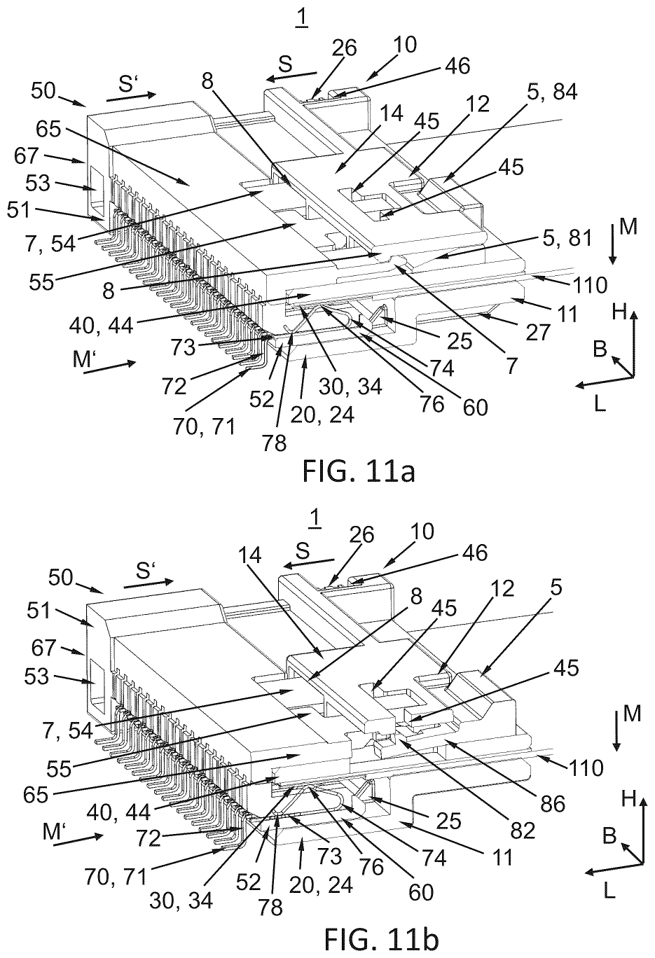

FIGS. 11a to 14b each a sectional illustration of a flat plug connector system, according to one embodiment of the present invention;

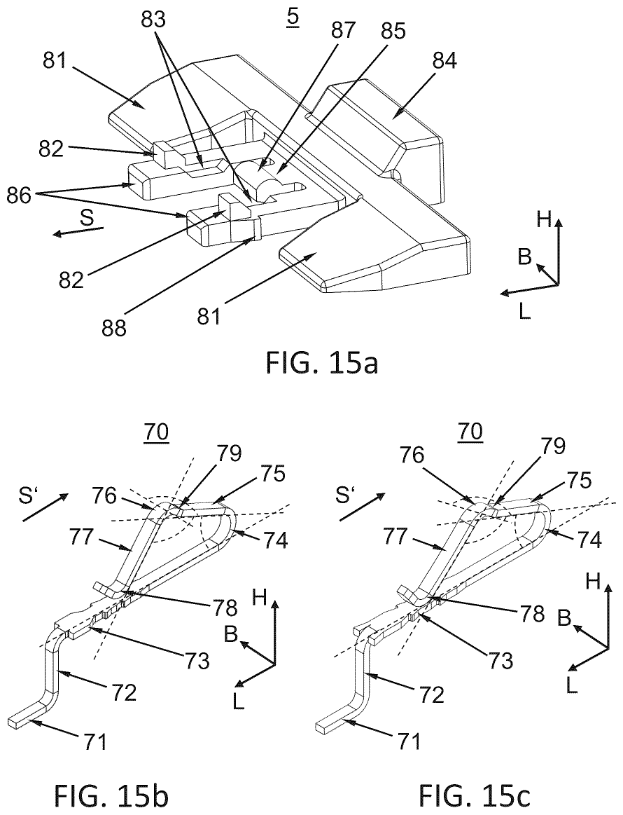

FIG. 15a a securing element, according to one embodiment of the present invention,

FIGS. 15b and 15c each a contact for a flat plug connector, according to one embodiment of the present invention;

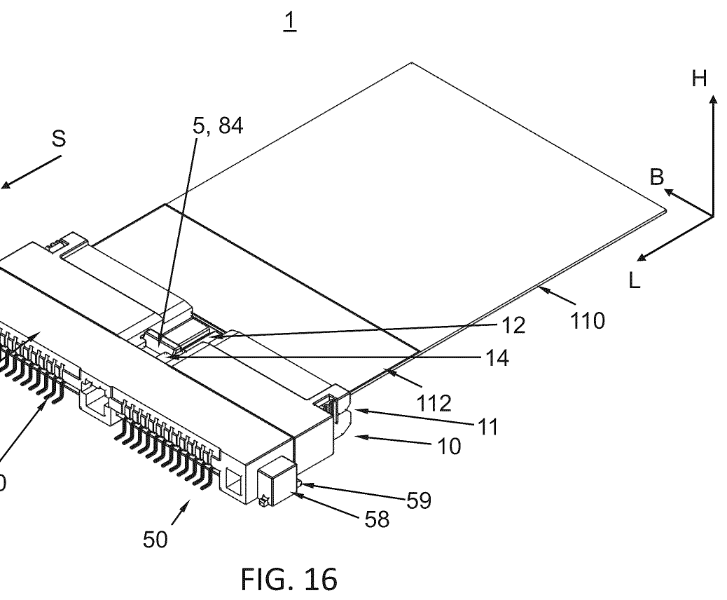

FIG. 16 an oblique view of a flat plug connector system, according to one embodiment of the present invention;

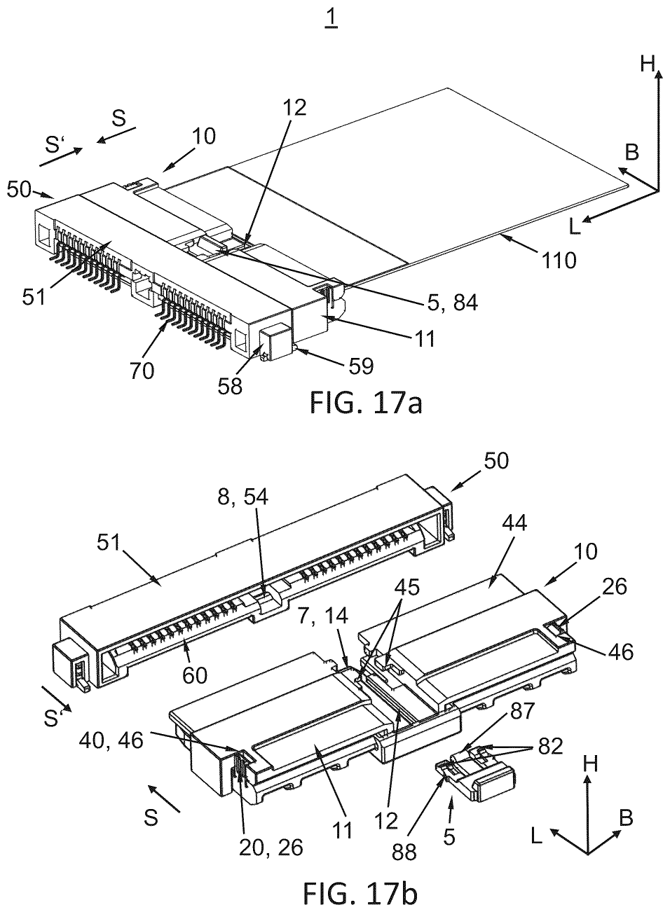

FIG. 17a an oblique view of a flat plug connector system, according to one embodiment of the present invention;

FIG. 17b an oblique view of a flat plug connector system, according to one embodiment of the present invention;

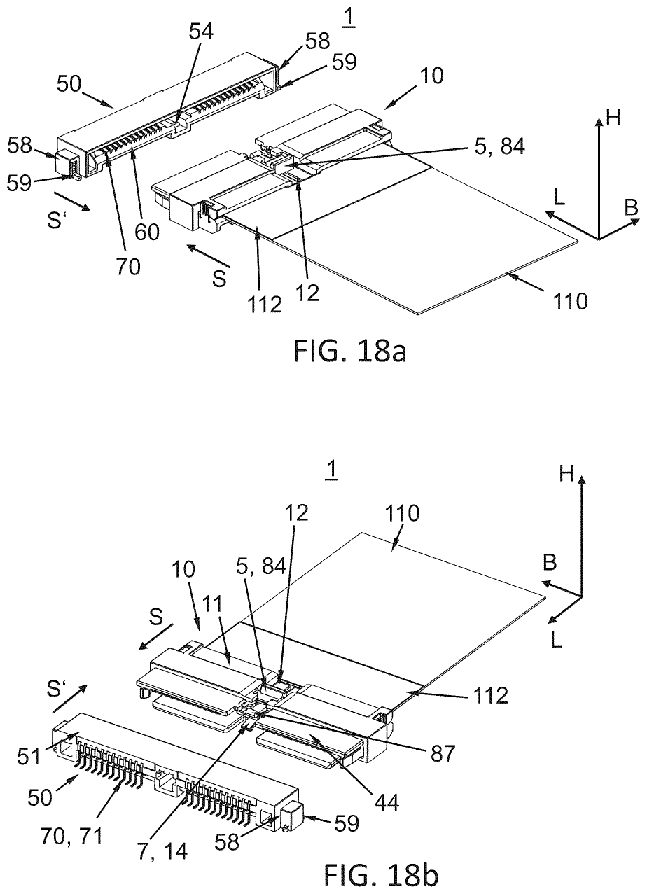

FIGS. 18a and 18b each an oblique view of a flat plug connector system, according to one embodiment of the present invention;

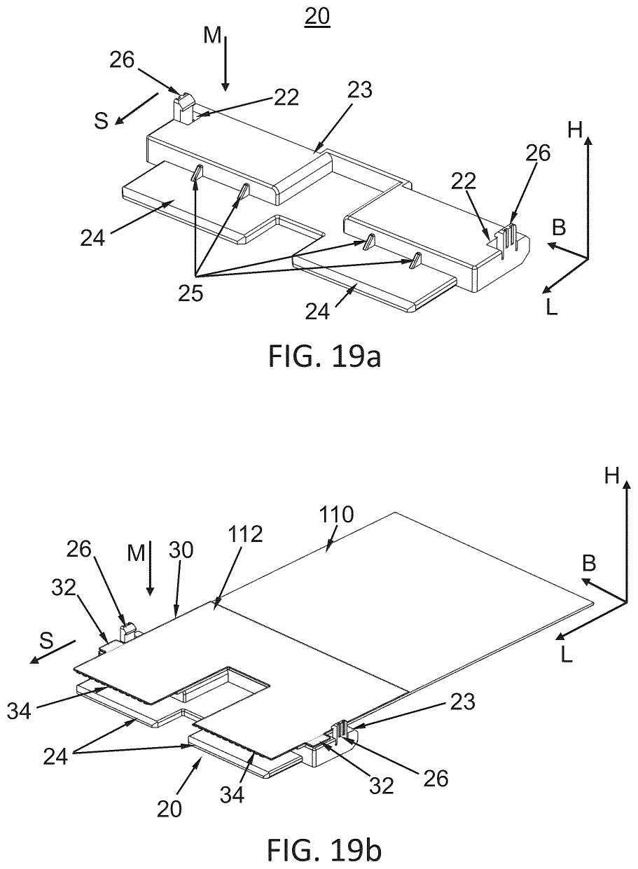

FIG. 19a an oblique view of a plug connector housing part, according to one embodiment of the present invention;

FIG. 19b an oblique view of a plug connector housing part of a flat plug connector with a conductor portion, according to one embodiment of the present invention;

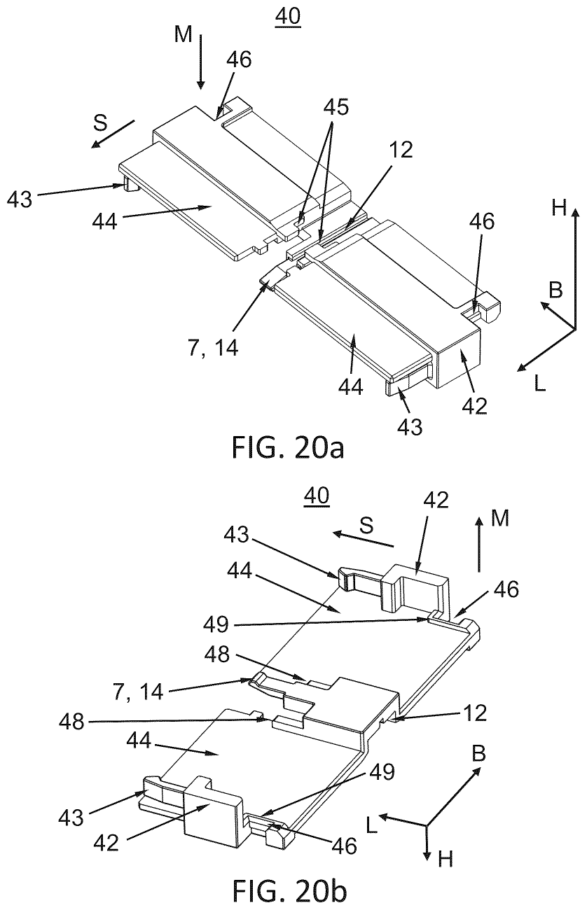

FIG. 20a an oblique view from above of a plug connector housing part of a flat plug connector, according to one embodiment of the present invention;

FIG. 20b an oblique view from below of a plug connector housing part of a flat plug connector, according to one embodiment of the present invention;

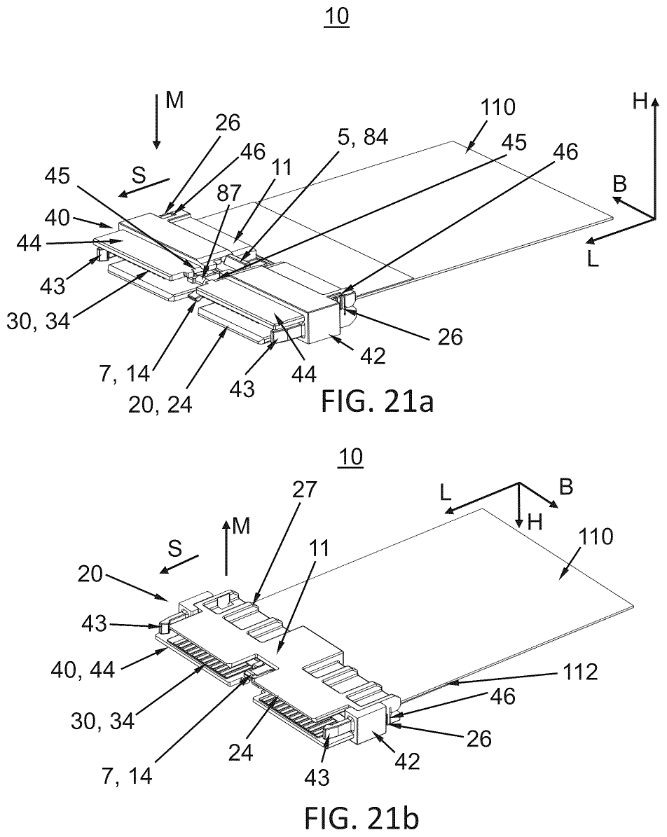

FIG. 21a an oblique view from above of a flat plug connector system, according to one embodiment of the present invention;

FIG. 21b an oblique view from below of a flat plug connector system, according to one embodiment of the present invention;

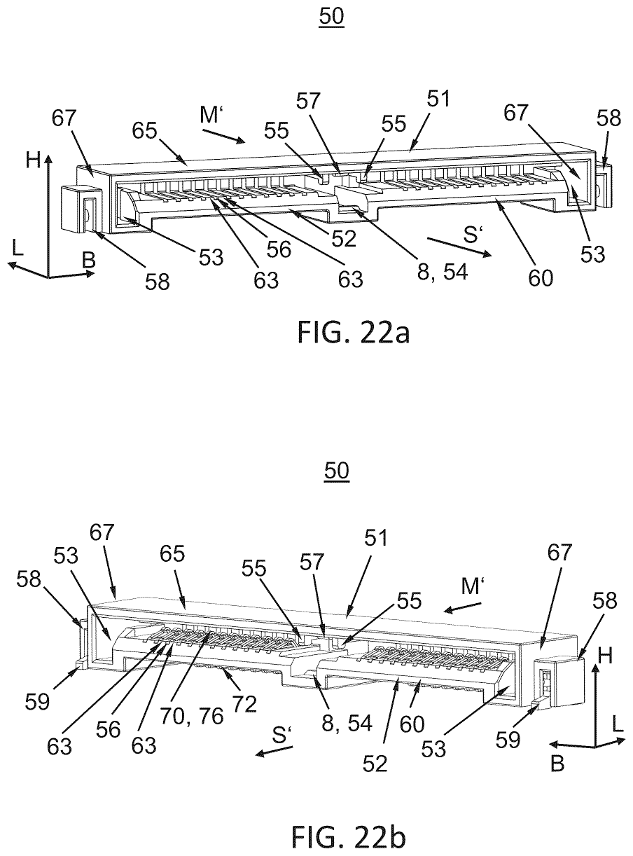

FIGS. 22a and 22b each an oblique view of a complementary flat plug connector, according to one embodiment of the present invention;

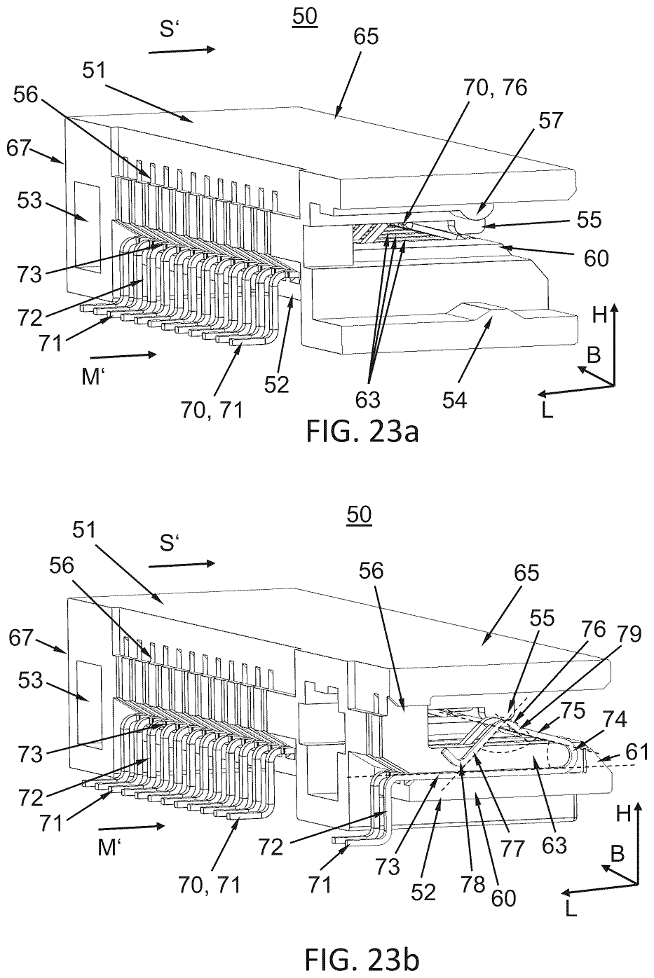

FIGS. 23a and 23b each a sectional illustration of a complementary flat plug connector, according to one embodiment of the present invention;

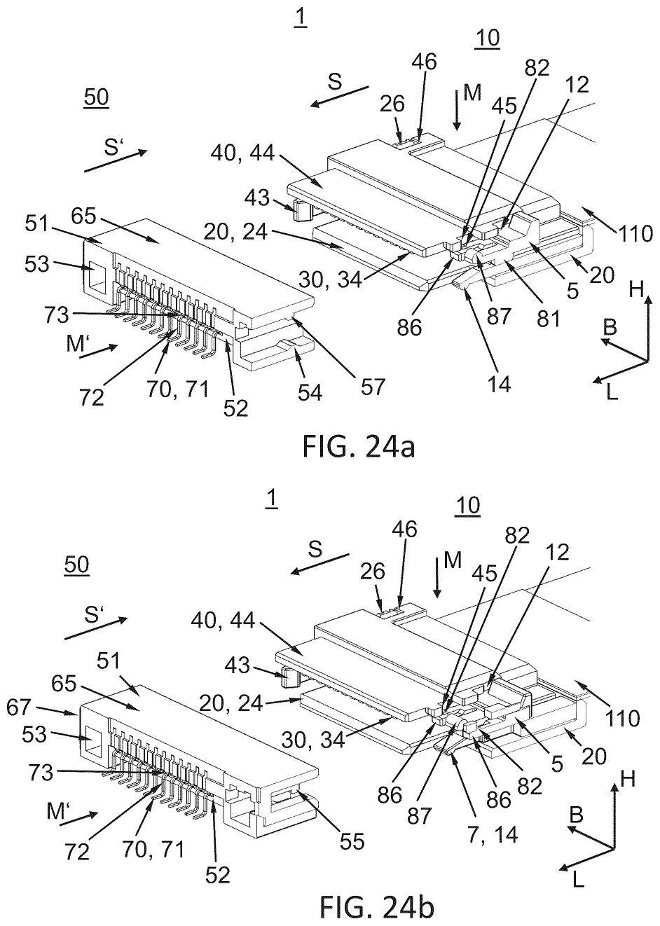

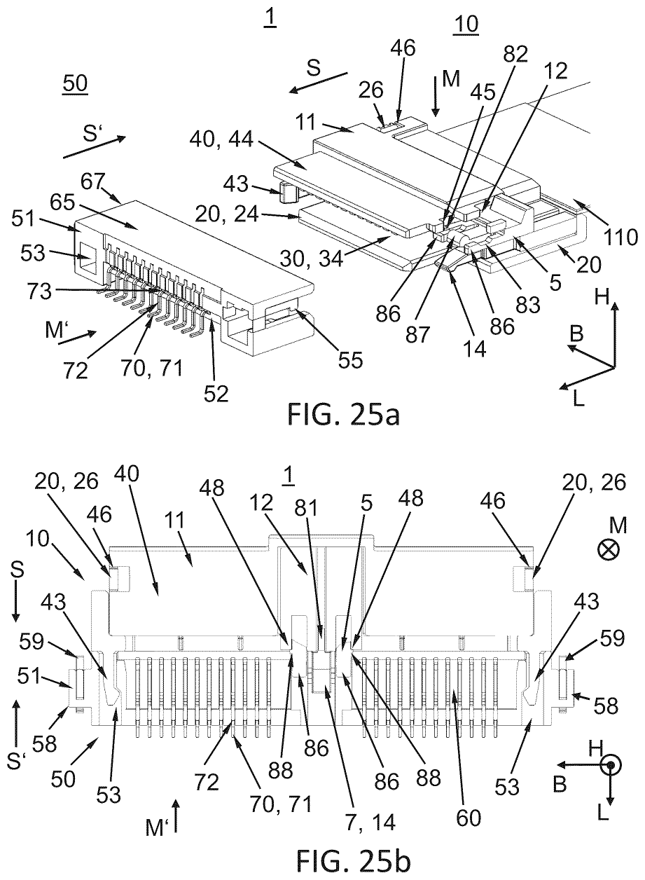

FIGS. 24a to 25a each a sectional illustration of a flat plug connector system, according to one embodiment of the present invention;

FIG. 25b a plan view of a sectional illustration of a flat plug connector system, according to one embodiment of the present invention;

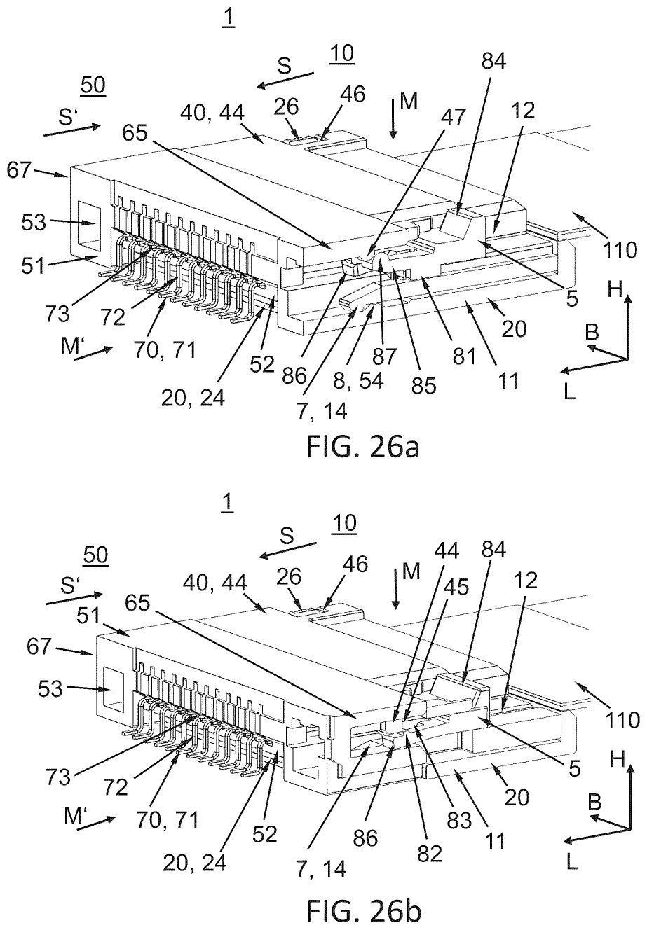

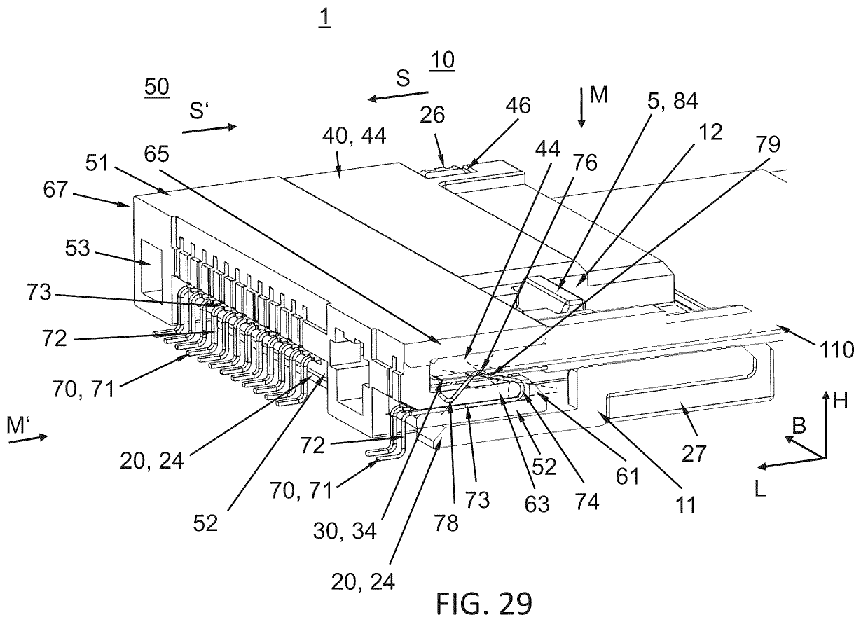

FIGS. 26a to 29 each a sectional illustration of a flat plug connector system, according to one embodiment of the present invention;

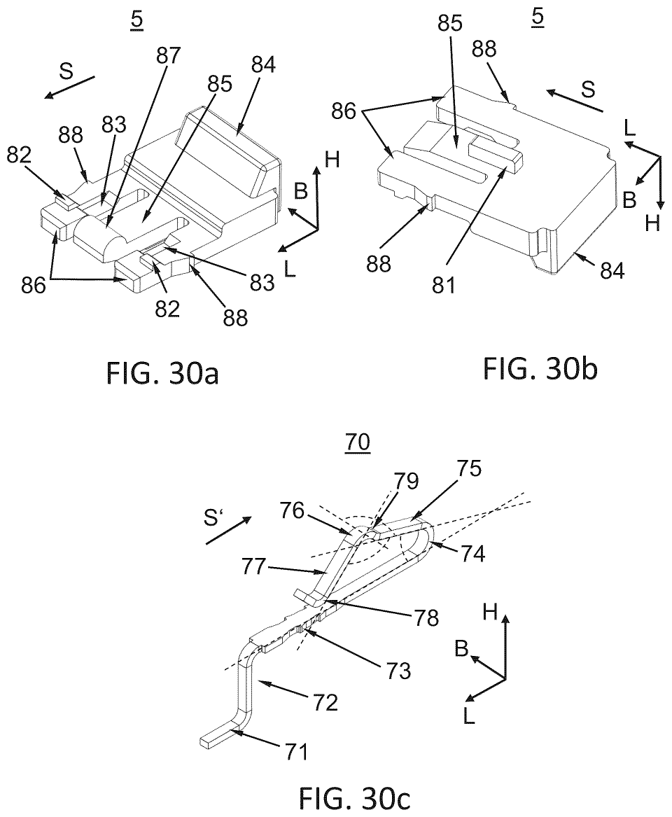

FIGS. 30a and 30b a securing element, according to one embodiment of the present invention, from above and from below;

FIG. 30c a contact for a flat plug connector, according to one embodiment of the present invention;

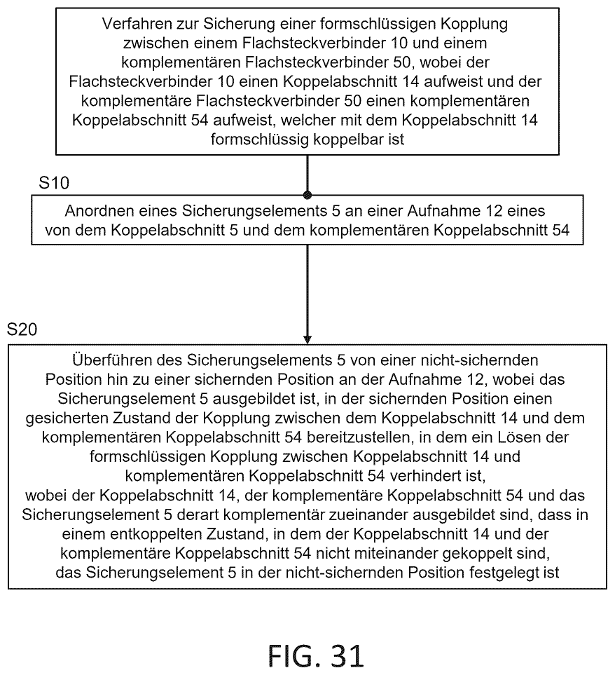

FIG. 31 a flowchart of a method for securing a form-fit coupling between a flat plug connector and a complementary flat plug connector, according to the present invention; and

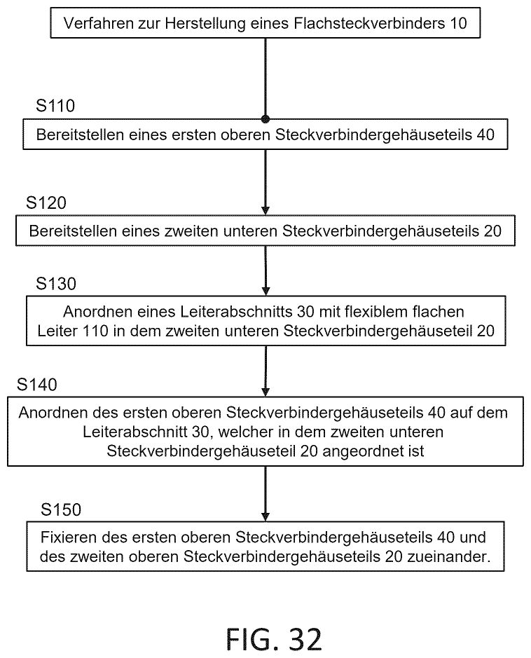

FIG. 32 a flowchart of a method for manufacturing a flat plug connector, according to the present invention.

FIGS. 1, 2a, 2b, 3a, 3b, 4a, 4b, 5a, 5b, 6a, 6b, 7a, 7b, 8a, 8b, 9a, 9b, 10a, 10b, 11a, 11b, 12a, 12b, 13a, 13b, 14a, 14b and 15a refer in particular to a first embodiment of a flat plug connector system 1.

FIGS. 16, 17a, 17b, 18a, 18b, 19a, 19b, 20a, 20b, 21a, 21b, 22a, 22b, 23a, 23b, 24a, 24b, 25a, 25b, 26a, 26b, 27a, 27b, 28a, 28b, 29, 30a and 30b refer in particular to a second embodiment of a flat plug connector system 1. The second embodiment of the flat plug connector system 1 has in particular a different coupling portion 14 and a different complementary coupling portion 54 than the first embodiment of the flat plug connector system 1. The second embodiment thereby advantageously enables a lower overall height of the flat plug connector system 1, while at the same time in particular secure assembly and securing of a coupled state can be ensured.

The flat plug connector system 1 of the first and second embodiments may, for example, have a height in the height direction H of less than about 7.5 mm, in particular less than about 6.5 mm, preferably less than about 6.0 mm, more preferably less than about 5.0 mm, particularly preferably less than about 4.5 mm, in particular in the secured state and/or in the unsecured state.

In particular, the flat plug connector system 1 of the second embodiment enables a height in the height direction H of less than 4.5 mm by virtue of the arrangement or formation of the coupling portion 14 and the complementary coupling portion 54 substantially in the width direction B between two groups of contacts 70 and between two portions of the conductor portion 30, as shown by way of example in FIG. 18b.

Unless explicitly emphasized otherwise, elements, their functions, relationships and method steps, which are explained with reference to the first embodiment of the flat plug connector system 1, refer equally to the second embodiment of the flat plug connector system 1, and vice versa.

FIGS. 15b and 15c refer in particular to a first embodiment of a contact 70. The contact 70, as shown in FIGS. 15b and 15c, may be used both in the first embodiment of the flat plug connector system 1 and in the second embodiment of the flat plug connector system 1, but is preferably used in the first embodiment of the flat plug connector system 1.

FIG. 30c refers in particular to a second embodiment of a contact 70. The contact 70, as shown in FIG. 30c, may be used both in the first embodiment of the flat plug connector system 1 and in the second embodiment of the flat plug connector system 1, but is preferably used in the second embodiment of the flat plug connector system 1.

The flowcharts in FIGS. 31 and 32 refer to all of the embodiments of the present flat plug connector systems 1.

FIGS. 1, 13a, 13b, 14a, 14b, 16, 27b, 28a, 28b and 29 refer in particular to a coupled state of the flat plug connector system 1, wherein the securing element 5 is arranged in the securing position in each case.

FIGS. 2a, 10b, 11a, 11b, 12a, 12b, 17a, 25b, 26a, 26b and 27a refer in particular to a coupled state of the flat plug connector system 1, wherein the securing element 5 is arranged in the non-securing position in each case.

FIGS. 3a, 3b, 6a, 6b, 9a, 9b, 10a, 18a, 18b, 21a, 21b, 24a, 24b and 25a refer in particular to a non-coupled or decoupled state of the flat plug connector system 1, wherein the securing element 5 is arranged in the non-securing position in each case.

The coupled state of the flat plug connector system 1, as shown in particular in FIGS. 1, 9a, 9b, 10a, 13a, 13b, 14a, 14b, 16, 18a, 18b, 21a, 24a, 24b, 25a, 27b, 28a, 28b and 29, refers to a state in which the coupling portion 14 of the flat plug connector 10 is engaged, in particular engaged in a form-fit manner, with the complementary coupling portion 54 of the complementary flat plug connector 50. The form-fit may in particular be formed substantially in parallel to the plugging direction S, S′, in particular formed substantially in parallel opposite to the plugging direction. In other words, the form-fit may in particular block a movement substantially in parallel to the plugging direction S, S′. Alternatively or additionally, the form-fit may be formed substantially in the height direction H.

As a result, for example, even a coupling that is not secured by the securing element 5 can advantageously already define a predetermined detaching force to detach the coupling between the flat plug connector 10 and the complementary flat plug connector 50 or between the coupling portion 14 and the complementary coupling portion 54. In the non-secured coupling, the securing element 5 is not arranged in the securing position. For example, the securing element 5 may be arranged in the non-securing position.

The non-securing position of the securing element 5, as shown for example in FIGS. 2a, 3a, 3b, 6a, 9a, 9b, 10a, 10b, 11a, 11b, 12a, 12b, 17a, 18a, 18b, 21a, 24a, 24b, 25a, 25b, 26a, 26b and 27a, is in particular a position in which the securing element 5 is arranged at least in sections at the receptacle 12.

In the non-securing position, an actuating portion 84 of the securing element 5 may project from the receptacle 12, in particular opposite to the plugging direction S (see especially FIGS. 3a, 3b, 9a, 9b and 10a for the first embodiment of the flat plug connector system 1).

In the non-securing position, a front side, in the plugging direction S, of the actuating portion 84 of the securing element 5 may in particular not abut against an upper wall 44 of the flat plug connector 10 or not be directly adjacent thereto.

It is to be understood that the non-securing position of the securing element 5 may also be a position of the securing element 5 remote from the receptacle 12, in which the securing element 5 does not secure the coupling between the flat plug connector 10 and the complementary flat plug connector 50.

In the coupled state, in particular one or more rear-engageable portions 8 may be engaged with one or more restorably rear-engaging elements 7, in particular engaged in a form-fit manner. The form-fit may in particular be formed substantially in parallel to the plugging direction S, S′, in particular substantially in parallel opposite to the plugging direction. Alternatively or additionally, the form-fit may be formed substantially in the height direction H.

The coupled state of the flat plug connector system 1 is in particular a state in which the coupling portion 14 and the complementary coupling portion 54 are coupled or engage with each other, or in other words rear-engage each other, and both the coupling portion 14 and the complementary coupling portion 54 have substantially no or no elastic deformation. Possible elastic deformations which are produced due to contact with the securing element 5, which in particular lead to elastic deformation of the securing element 5, are not taken into account here. For this purpose, the coupling portion 14 and/or the complementary coupling portion 54 may in particular be configured to be comparatively rigid relative to the one or more restorable, in particular elastically restorable prongs 85, 86 of the securing element 5.

As shown in particular by FIGS. 2b, 3a, 3b, 17b, 18a and 18b, the plug connector housing 11 of the flat plug connector 10 and the plug connector housing 51 of the complementary flat plug connector 50 may in particular be configured in a poka-yoke shape with respect to each other.

In particular, the plug connector housing 11 of the flat plug connector 10 and the plug connector housing 51 of the complementary flat plug connector 50 may be configured to be complementary to each other such that coupling of the flat plug connector 10 to the complementary flat plug connector 50 is blocked or, in other words, is not allowed when one of the two plug connector housings 11, 51 is rotated about the plugging direction S, S′, in particular by 180°.

As shown by the figures of the first and second embodiments of the flat plug connector system 1 with regard to the coupled state, one of the coupling portion 14 and the complementary coupling portion 54 may have one or more rear-engageable portions 8, and the other one of the coupling portion 14 and the complementary coupling portion 54 may have one or more restorably rear-engaging elements 7. Here, a restorably rear-engaging element 7 may in particular be configured to rear-engage one or more rear-engageable portions 8 in the coupled state. A rear-engageable portion 8 may in particular be configured to be rear-engaged by one or more restorably rear-engaging elements 7 in the coupled state. A rear-engageable portion 8 of the one or more rear-engageable portions 8 may in particular be configured to be comparatively rigid as compared to a restorably rear-engaging element 7 of the one or more restorably rear-engaging elements 7.

The rear engagement, or also the engagement, between the coupling portion 14 and the complementary coupling portion 54 comprises in particular an engagement substantially perpendicular to the plugging direction S, S′.

As shown in the figures of the first and second embodiments of the flat plug connector system 1 with regard to the coupled state, and illustrated therein in particular in FIGS. 11a, 13a, 26a and 27b, the rear-engageable portion 8 and/or the restorably rear-engaging element 7 may, at least in sections, extend substantially in the height direction.

As a result, a reliable and securable form-fit coupling relative to the plugging direction S, S′ can advantageously be ensured.

If the securing element 5 is arranged at the receptacle 12, for example by a step of arranging the securing element 5 at the receptacle 12, which can be carried out in particular as part of a pre-assembly of the flat plug connector system 1, the securing element 5 may either be arranged in the securing position or in the non-securing position.

If the securing element 5 is arranged at the receptacle 12 and the flat plug connector system 1 is in the coupled state, as shown for example in FIGS. 1, 2a, 13a, 13b, 14a, 14b, 16, 18a, 18b, 21a, 24a, 24b, 25a, 27b, 28a, 28b and 29, the securing element 5 is in particular transferable between the securing position and the non-securing position, in particular transferable in a non-destructive manner.

If the securing element 5 is arranged at the receptacle 12 and the flat plug connector system 1 is in the decoupled state or non-coupled state, as shown for example in FIGS. 3a, 3b, 6a, 6b, 9a, 9b, 10a, 18a, 18b, 21a, 21b, 24a, 24b and 25a, the securing element 5 is retained in particular in the non-securing position. The non-securing position may in particular be characterized by one or more form-fits in parallel to the plugging direction S, S′. In exemplary embodiments, the one or more form-fits, in particular of the securing element 5 relative to the receptacle 12, may in particular define a position or arrangement in or from which the securing element 5 is not transferable into the securing position in a non-destructive manner.

As a result, a simple assembly of the flat plug connector system 1 can be advantageously provided, in which the securing element 5 can be pre-assembled to the receptacle 12, for example, without the securing element 5 impairing the coupling between the flat plug connector 10 and the complementary flat plug connector 50.

As shown in the figures of the first and second embodiments of the flat plug connector system 1, the flat plug connector system 1 has in particular a first flat plug connector 10 and a second flat plug connector 50 complementary to the first flat plug connector 10.

The flat plug connector 10 and the complementary flat plug connector 50 are couplable to each other. The flat plug connector 10 and the complementary flat plug connector 50 are in particular electrically conductively connectable to each other.

For example, one of the flat plug connector 10 and the complementary flat plug connector 50 may have one or more electrically conductive conductor portions 30 and the other one of the flat plug connector 10 and the complementary flat plug connector 50 may have one or more electrically conductive contacts 70. The one or more electrically conductive conductor portions 30 are in particular electrically conductively connectable to one or more electrically conductive contacts 70.

In exemplary embodiments, a contact 70 of the one or more electrically conductive contacts 70 may be configured to be restorable, in particular elastically restorable, to be able to contact the one or more conductor portions 30, in particular with a bias.

In exemplary embodiments, a contact 70 of the one or more electrically conductive contacts 70 can contact the one or more conductor portions 30 when the flat plug connector system 10 is in the coupled state, in particular exclusively when the flat plug connector system 10 is in the coupled state.

As a result, reliable electrically conductive contacting between the flat plug connectors 10, 50 can advantageously be ensured.

A contact 70 of the one or more contacts 70 is connectable to an electronic component (not shown in the figures) such as a printed circuit board, in particular a PCB, for example, in particular by means of a terminal portion 71. A contact 70 may be connectable to the electrical component by means of soldering, in particular by means of reflow soldering, for example. The contact 70 may in particular be configured to be solderable, in particular reflow solderable. Alternatively or additionally, in particular a plug connector housing 51 of the complementary flat plug connector 50 may be configured to be solderable, in particular reflow solderable.

The plug connector housing 51, as shown by way of example in particular in FIGS. 7a, 7b, 22a and 22b, may in particular be an injection-molded component. In particular, the plug connector housing 51 may comprise or consist of a polymer material. For example, but not limited thereto, the plug connector housing 51 may comprise or consist of polyamide (PA), partially aromatized polyamide, for example PA66, PA6t, and/or PA9T, polyphenyl sulfones (PPSE), polyether sulfones (PES), polyether imides (PEI), polyphenylene sulfides (PPS), liquid crystal polymers (LCP), polyethylene (PE), polyether ether ketone (PEEK), and/or polypropylene (PP).

Preferably, the plug connector housing 51 comprises a polymer material which is reflow solderable, i.e. which is configured to withstand in particular temperatures which occur during reflow soldering in a dimensionally stable manner. The plug connector housing 51 may therefore preferably in particular comprise or consist of polyamide (PA) and/or PEEK.

In exemplary embodiments, the plug connector housing 51 may in particular be formed in one piece.

In alternative embodiments, the plug connector housing 51 may in particular be formed in multiple pieces. For example, the plug connector housing 51 may be a multi-component injection molded component.

As a result, the plug connector housing 51 can be advantageously formed in an inexpensive, dimensionally stable and electrically insulating manner and with repeat accuracy.

The complementary flat plug connector 50 or the plug connector housing 51 thereof has in particular a contact holder 60 at which the plurality of contacts 70 is arranged. The contact holder 60 may have a plurality of contact receptacles 56.

The plug connector housing 51 has in particular a number of contact receptacles 56 corresponding to the number of contacts 70 to be received. The plug connector housing 51 may in particular be configured to receive 24, 32, 64 or 96 contacts 70 or more. The contact receptacles 56 may in particular be configured as section-wise hollow molds, in particular as hollow molds that are substantially separated from each other in the width direction B.

The plug connector housing 51 may in particular have openings, on a rear side in the plugging direction S′, i.e. on a side facing away from the flat plug connector 10 during coupling, which open in particular into the contact receptacles 56. The rear side of the plug connector housing 51 may be closed, in particular aside from the openings and aside from receptacles which are in particular configured to receive elements of the flat plug connector 10. The openings may in particular have a width in the width direction B which substantially corresponds to the width in the width direction B of the contacts 70. The contacts 70 may in particular be fixable to the plug connector housing 51 from the rear side of the plug connector housing 51 in the assembly direction M′, in particular through the openings that open into the contact receptacles 56. The assembly direction M′ of the contacts 70 at the plug connector housing 51 of the complementary flat plug connector 50 may substantially correspond to the plugging direction S′ of the complementary flat plug connector 50.

The contact receptacles 56 may be separated from each other in the width direction B in particular by support walls 63. In other words, the contact receptacles 56 may in particular be substantially limited in the width direction B by support walls 63.

The support walls 63 may have an extension which is in particular substantially parallel to the height direction H and/or substantially parallel to the longitudinal direction L.

The support walls 63 may in particular have an extension which is shorter, i.e. in particular projects less far (upwards) in the height direction H than an extension of the contacts 70 arranged between the support walls 63. For example, the support walls 63 may have such an extension that at least or exclusively the bent contact regions 76 of the contacts 70 arranged between the support walls 63 are exposed, i.e. are not delimited by the support walls 63 in the width direction B.

The support walls 63 advantageously allow to guide the contacts 70 into the plug connector housing 51 during assembly. In particular, the contacts 70 may be advantageously guided into the predetermined contact receptacles 56 by the support walls 63, even in the case of assembly deviating from the assembly direction M′. Furthermore, the support walls 63 advantageously allow to guide the contacts 70, in particular in the case of a restorable deformation of the contacts 70, for example in the case of coupling to the flat plug connector 10. By the extension of the support walls 63, in particular in the height direction H, the contacts 70 may be advantageously protected, while at the same time contacting with contacts 34 or conductor elements 34 complementary to the contacts 70 with a predetermined contact force can be ensured. Thus, reliable electrically conductive contacting and at the same time a long service life of the contacts 70 can be advantageously ensured.

The plug connector housing 51 of the complementary flat plug connector 50 may in particular have a lower wall 52, a front wall 61, an upper wall 65, and/or one or more side walls 67. By the one or more walls 52, 61, 65, 67 protection for the contacts 70, in particular both before coupling to the flat plug connector 10 and during coupling to the flat plug connector 10, can advantageously be provided.

The front wall 61 limits the contact receptacles 56 in particular towards the front in the plugging direction S′ of the complementary flat plug connector 50. The front wall 61 may in particular be formed in one piece with the support walls 63, in particular such that the front wall 61 forms a front portion, in the plugging direction S′, of the support walls 63.

The front wall 61 may have an extension which is shorter, i.e. in particular projects less far (upwards) in the height direction H, than an extension of the contacts 70 arranged between the support walls 63 or in the contact receptacles 56. For example, the front wall 61 may have such an extension that at least or exclusively the bent contact regions 76 of the contacts 70 arranged between the support walls 63 are exposed, i.e. are not delimited by the front support wall 61 along the plugging direction S′. The front wall 61 may in particular have such an extension that at least the bent portions 74 of the contacts 76 are (being) delimited by the front wall 61 along the plugging direction S′, as illustrated by way of example by FIGS. 8b, 10a, 11a, 11b, 12a, 12b, 14a, 14b, 23b and 29.

The front wall 61 may have in particular a chamfer or insertion slope at an upper end in the height direction H and/or at a lower end in the height direction H.

The front wall 61 advantageously allows to protect the contacts 70 both before and during coupling, in particular in the plugging direction S, S′ or in the longitudinal direction L, and to facilitate the coupling. As a result, advantageously both assembly can be facilitated and the service life of the contacts 70 and the flat plug connector system 1 can be improved.

The plug connector housing 51 of the complementary flat plug connector 50 may in particular have a lower wall 52. The lower wall 52 may in particular be formed in one piece with the support walls 63 and/or the front wall 61, in particular such that the front wall 61 forms a front portion, in the plugging direction S′, of the lower wall 52.

The lower wall 52 may in particular form a rest for the contacts 70. In other exemplary embodiments, the contacts 70, in particular with the retaining portion 73, may be guided in grooves which may in particular be arranged in the support walls 63.

The lower wall 52 advantageously allows to protect the contacts 70 both before and during coupling, in particular in the height direction. Furthermore, the lower wall 52 advantageously provides a reliable counterhold for the retaining portions 73 of the contacts 70, in the case of restorable contacting of the contacts 70 by the conductor elements 34, wherein the support portion 78 of the contact 70 is supported against the retaining portion 73. As a result, in turn, a predetermined contact force, and correspondingly reliable electrically conductive contacting, can advantageously be ensured with repeat accuracy.

The plug connector housing 51 of the complementary flat plug connector 50 may in particular have an upper wall 65. The upper wall 65 may in particular be formed in one piece with the support walls 63, the front wall 61 and/or the lower wall. The upper wall 65 may be spaced apart from the lower wall 52 and/or the front wall 61, in particular in the height direction H, to enable insertion and/or reception of a conductor portion 30 of the flat plug connector 10 in the plugging direction S, S′.

An opening of the plug connector housing 51 towards the front in the plugging direction S′, between the upper wall 65 and the front wall 61, or between the upper wall 65 and the support walls 63, in particular substantially in the height direction H, is in particular less than about 2 mm, in particular less than about 1.8 mm, in particular about 1.5 mm.

The contact holder 60 may in particular comprise or consist of the support walls 63, the lower wall 52, and/or the front wall 61. In other words, the contact holder 60 in particular comprises or consists of those portions of the plug connector housing 51 which are directly adjacent to the contacts 70 in the operating state of the complementary plug connector 50, or in still other words are configured to support or hold the contacts 70 in the operating state.

The contact holder 60 is in particular configured to be (completely) received between the lower plug connector housing part 20 and the upper plug connector housing part 40, in particular in a coupled state of the flat plug connector system 1, or to be received in particular when coupling the flat plug connector 10 to the complementary flat plug connector 50.

As a result, an efficient touch protection can advantageously be provided.

The upper wall 65 may have in particular a chamfer or insertion slope at an upper end, in the height direction H, and/or at a lower end, in the height direction H, of the front end, in the plugging direction S′, of the upper wall 65. The upper wall may extend in particular further in the plugging direction S′ or opposite to the longitudinal direction L than the contacts 70 received underneath.

The upper wall 65 advantageously allows to protect the contacts 70 both before and during coupling, in particular in the height direction H.

The plug connector housing 51 of the complementary flat plug connector 50 may in particular comprise one or more side walls 67, in particular a pair of side walls 67 substantially opposite each other in the width direction B. The one or more side walls may in particular be formed in one piece with the upper wall 65, the support walls 63, the front wall 61, and/or the lower wall.

The one or more side walls 67 advantageously allow to protect the contacts 70 both before and during coupling, in particular in the width direction B.

The plug connector housing 51 of the complementary flat plug connector 50 may have openings and receptacles through the walls, in particular open exclusively substantially in the plugging direction S, S′.

At the plug connector housing 51, a coupling portion 54 may in particular be arranged. The coupling portion 54 may in particular be formed in one piece with the plug connector housing 51.

The coupling portion 54 may, without being limited thereto, and as shown by way of example with reference to the figures of the first embodiment of the flat plug connector system 1, be arranged at a front end, in the plugging direction S′, of the upper wall 65, for example. The coupling portion 54 may, for example, extend substantially in the plugging direction S′ or substantially opposite to the longitudinal direction L from the plug connector housing 51, in particular towards the flat plug connector 10 to be coupled. The coupling portion 54 may in particular extend further in the plugging direction S′ or further opposite to the longitudinal direction L than the remaining plug connector housing 51.

As further shown by way of example with reference to the figures of the second embodiment of the flat plug connector system 1, the coupling portion 54, without being limited thereto, may be arranged at the lower wall 52, for example arranged at the lower wall 52 centrally in the longitudinal direction L.

At the plug connector housing 51, a release element 55 may in particular be arranged. The release element 55 may in particular be formed in one piece with the plug connector housing 51.

The release element 55, without being limited thereto, and as shown by way of example with reference to the figures of the first embodiment of the flat plug connector system 1, may be arranged, at a front end, in the plugging direction S′, of the upper wall 65, for example. The release element 55 may, for example, extend substantially in the plugging direction S′ or substantially opposite to the longitudinal direction L from the plug connector housing 51, in particular towards the flat plug connector 10 to be coupled. The release element 55 may extend in particular further in the plugging direction S′ or further opposite to the longitudinal direction L than the remaining plug connector housing 51. In exemplary embodiments, the release element 55 may extend approximately as far from the plug connector housing 51 as the coupling portion 54.

As further shown by way of example with reference to the figures of the second embodiment of the flat plug connector system 1, the release element 55, without being limited thereto, may be arranged at the upper wall 65, for example arranged at the upper wall 65 centrally in the longitudinal direction L.

As shown by way of example with reference to the figures of the first embodiment of the flat plug connector system 1, the plug connector housing 51 of the complementary flat plug connector 50 may be configured to receive all contacts 70 with a substantially constant spacing between the contacts 70 in the width direction B. As a result, a complementary flat plug connector 50 that is not only flat, but in particular narrower in the width direction B can advantageously be provided.

As further shown by way of example with reference to the figures of the second embodiment of the flat plug connector system 1, the plug connector housing 51 of the complementary flat plug connector 50 may be configured to receive two or more groups of contacts 70, wherein the contacts 70 of the respective group have a different spacing from one another in the width direction B than the groups have from one another.

In other words, in exemplary embodiments, the plug connector housing 51 may have a first group of contact receptacles 56, have the coupling portion 54, and have a second group of contact receptacles 56 in succession in the width direction B in this order. In the respective contact receptacles 56, in particular the contacts 70 may be arranged.

In still other words, and as shown by way of example with reference to the figures of the second embodiment of the flat plug connector system 1, the coupling portion 54 of the complementary flat plug connector 50 may in particular be arranged substantially in the width direction B between a first group of contacts 70 or a first group of contact receptacles 56 and a second group of contacts 70 or a second group of contact receptacles 56.

As a result, the complementary flat plug connector 50 and the flat plug connector system 1 may be advantageously configured to be particularly flat. As a result, in turn, the integration of the flat plug connector system 1 in systems with limited installation space, in particular with limited installation space in the height direction H, such as in motor vehicles, for example cars, can advantageously be improved.

In exemplary embodiments, the plug connector housing 51 of the complementary flat plug connector 50 may have one or more fixing portions 58. The one or more fixing portions 58 may, for example, be configured for receiving one or more fixing means 59, in particular be configured for receiving one or more fixing means 59 in a form-fit manner. The one or more fixing portions 58 may be arranged at an outer side of the plug connector housing 51 in the width direction B, in particular arranged at the plug connector housing 51 in pairs substantially opposite one another in the width direction B.

By virtue of the fixing portions 58, the integration of the complementary flat plug connector 50 and the flat plug connector system 1, and furthermore in particular the pre-assembly capability of the complementary flat plug connector 50 can advantageously be improved.

As shown by the figures relating to the first and second embodiments of the flat plug connector system 1, and illustrated in particular by FIGS. 4a, 4b, 5a, 5b, 19a, 19b, 20a and 20b, the flat plug connector 10, which has the conductor portion 30, may in particular be configured in multiple pieces, at least in two pieces. In other words, in particular the plug connector housing 11 of the flat plug connector 10, which has the conductor portion 30, may be configured in multiple pieces, in particular be configured at least in two parts or two pieces. The plug connector housing 11 is thus in particular configured as a two-part plug connector housing 11.

The flat plug connector 10, and in particular the plug connector housing 11 thereof, may in particular comprise or consist of a lower plug connector housing part 20 and an upper plug connector housing part 40.

The lower and upper plug connector housing parts 20, 40 may comprise, at least in sections, a separating line or a separating plane which extends substantially planarly, in particular complementary to the conductor portion 30.

As a result, the conductor portion 30 may advantageously be and/or become arranged between the lower plug connector housing part 20 and the upper plug connector housing part 40. For example, the conductor portion 30 may be and/or become arranged in a sandwich-like manner, at least in sections, between the lower plug connector housing part 20 and the upper plug connector housing part 40.

The flat plug connector 10 may in particular be manufactured by stacking step-by-step. First, the conductor portion 30 may be arranged, or in other words laid, on or in one of the lower plug connector housing part 20 and the upper plug connector housing part 40. Subsequently, the other one of the lower plug connector housing part 20 and the upper plug connector housing part 40 may be arranged or laid on or in the one of the lower plug connector housing part 20 and the upper plug connector housing part 40 at which the conductor portion 30 is arranged. Thereafter, the lower plug connector housing part 20 and the upper plug connector housing part 40 may be fastened relative to each other.

The step-by-step stacking described above may in particular be arranged or laid substantially in parallel to the height direction H. In exemplary embodiments, the step-by-step stacking described above may be arranged or laid in particular substantially in the assembly direction M. The assembly direction M shown in the figures describes, by way of example, the sequence according to which the upper plug connector housing part 40 is arranged, or in other words laid, on or in the lower plug connector housing part 20. It is to be understood that the flat plug connector 10 may also be manufactured by means of an assembly direction which is substantially opposite to the assembly direction M shown in the figures, according to which the lower plug connector housing part 20 is arranged, or in other words laid, on or in the upper plug connector housing part 40.

By arranging or laying substantially in parallel to the height direction H, kinking or deformation of the conductor portion 30 and/or the flexible flat conductor 110, which is connected to the conductor portion 30, can advantageously be avoided.

Conventionally, the conductor portion and/or the flexible flat conductor, which is connected to the conductor portion, is plugged into a plug connector housing, for example in the longitudinal direction, and subsequently fixed to the plug connector housing at fixing portions projecting in the width direction, for example by soldering, welding, screwing or clamping. Although this allows the conductor portion with the flexible flat conductor to be securely assembled to the plug connector housing, a part of the conductor portion and/or a part of the flexible flat conductor usually kinks when inserted, which may lead in particular to damage to the conductor portion and/or the flexible flat conductor, which is not clearly visible and is often only noticeable in a comparatively short service life of the flat plug connector system.

In the present manufacture of the flat plug connector 10, in particular kinking of the conductor portion 30 and the flexible flat conductor 110 can be avoided by arranging or laying them substantially in parallel to the height direction H. As a result, in turn, the service life of the conductor portion 30 and/or the flexible flat conductor 110, as well as the flat plug connector system 1 can advantageously be improved.

The conductor portion 30 may in particular comprise one or more conductor elements 34 and/or comprise a portion supporting the one or more conductor elements 34. The conductor elements 34 are in particular configured to be electrically conductive. The conductor elements 34 may comprise or consist of exposed conductor elements 34 of the flexible flat conductor 110.

The flexible flat conductor 110 may in particular comprise or consist of a ribbon or a flexible printed circuit board.

In preferred embodiments, the spacing of a center of the outermost conductor element 34 in the width direction B to the edge of the conductor portion 30 adjacent in the width direction B may be in the range from about 0.7 mm to about 1.2 mm. In particular, the spacing between a center of the outermost conductor element 34 in the width direction B and the edge of the conductor portion 30 adjacent in the width direction B may be at least about 0.9 mm or at least about 1.0 mm, in particular about 1 mm.

As a result, the conductor portion 30 is advantageously configured to be compatible with both a ribbon and a flexible printed circuit board, and furthermore advantageously enables modular manufacture of the flat plug connector system 1.

The lower plug connector housing part 20 has in particular a main body 23. The main body 23 has a main extension which is substantially parallel to the longitudinal direction L and the width direction B.

As a result, the main body 23 may advantageously be or be brought into contact with the conductor portion 30 and/or with the flat flexible conductor 110 in a planar manner.

As illustrated in particular by FIGS. 4a, 4b, 19a and 19b of the first and second embodiments of the flat plug connector system 1, the main body 23 may extend in particular in steps. The main body 23 may in particular have an upper step in the height direction H and at least one lower step in the height direction H, or, for example, have exclusively the upper step and the lower step.

The upper step in the height direction H has in particular a main extension which is substantially parallel to the longitudinal direction L and the width direction B. Additionally or alternatively, the at least one or exclusively other lower step in the height direction H may have a main extension which is substantially parallel to the longitudinal direction and the width direction. The upper and lower steps may in particular be substantially parallel to each other.

The upper step, in the height direction H, of the main body 23 may in particular be a step of the main body 23 facing the conductor portion 30 and/or the flexible flat conductor 110. The upper step, in the height direction H, of the main body 23 may provide a rest for the conductor portion 30 and/or the flexible flat conductor 110, in particular in the assembled state of the flat plug connector 10 or already during the manufacture of the flat plug connector 10.

The lower step, in the height direction H, of the main body 23 may in particular be a step of the main body 23 facing away from the conductor portion 30 and/or the flexible flat conductor 110. The lower step, in the height direction H, of the main body 23 may provide a spacing with respect to the conductor portion 30 and/or the flexible flat conductor 110, in particular a spacing substantially in the height direction H, in particular in the assembled state of the flat plug connector 10 or already during the manufacture of the flat plug connector 10.

The lower step in the height direction H may in particular comprise or consist of a lower wall 24 of the lower plug connector housing part 20.

In the assembled state of the flat plug connector 10, the lower wall 24 extends in particular with a spacing in the height direction H with respect to the conductor portion 30 and/or the flexible flat conductor 110.

The lower wall 24 has in particular a main extension which is parallel to the longitudinal direction L and the width direction B. The lower wall 24 may in particular extend, or in other words be arranged, at a lower end, in the height direction H, of the lower plug connector housing part 20.

The lower wall 24 may in particular extend further in the longitudinal direction L or in the plugging direction S than the conductor elements 34 arranged at the flat plug connector 10.

The lower wall 24 advantageously provides protection for the conductor portion 30 and/or the flexible flat conductor 110, in particular in the height direction H.

The lower wall 24 may in particular have a chamfer or insertion slope at a distal end, or in other words at a front end in the plugging direction S of the flat plug connector 10. The chamfer or insertion slope may in particular be formed on an upper side, in the height direction H, of the lower wall 24.

As a result, the lower wall 24 of the lower plug connector housing part 20 can advantageously be simply assembled in the plugging direction S, S′ with the plug connector housing 51 of the complementary flat plug connector 50, and in particular simply adjacent to the lower wall 52 of the complementary flat plug connector 50.

The lower plug connector housing part 20 has in particular one or more fastening means 26 for fastening the lower plug connector housing part 20 to the upper plug connector housing part 40. The upper plug connector housing part 40 may have one or more fastening means 46 for fastening the lower plug connector housing part 20 to the upper plug connector housing part 40, which are in particular complementary to the one or more fastening means 26 of the lower plug connector housing part 20.

As shown by way of example in particular in FIGS. 4a, 4b, 19a and 19b, the fastening means 26 of the lower plug connector housing part 26 has, by way of example, a protrusion, in particular an arm having a protrusion. The fastening means 26 may comprise or consist of a restorable, in particular elastically restorable clip. As shown by way of example in particular in FIGS. 5a, 5b, 20a and 20b, the fastening means 46 of the upper plug connector housing part 40 has or may consist of a fastening receptacle 46. In further exemplary embodiments, the fastening means 46 of the upper plug connector housing part 40 may comprise or consist of a protrusion and in particular a clip, and the fastening means 26 of the lower plug connector housing part 20 may comprise or consist of a receptacle. In still further exemplary embodiments, both the lower and the upper plug connector housing parts 20, 40 may comprise a protrusion and in particular a clip, as well as a receptacle as fastening means.

It is to be understood that in other exemplary embodiments, other fastening means than those shown in the figures may be used, in particular to connect the lower plug connector housing part 20 to the upper plug connector housing part 40. Other exemplary fastening means of the lower plug connector housing part 20 and/or the upper plug connector housing part 40 may comprise, but are not limited to, pins, fitting pins, openings, fitting openings, grooves, groove blocks, fir-tree shaped clips and/or screws.

For example, the lower plug connector housing part 20 may have fastening means 26 substantially opposite each other in the width direction B. The fastening means 26 may in particular each be arranged or formed at an end, in the width direction B, of the lower plug connector housing part 20.

The fastening means 26 may in particular comprise an elastically restorable clip arm which extends substantially in the height direction H. The clip arm may have a protrusion which may in particular protrude substantially in the width direction B from the clip arm. On a side of the clip arm opposite the protrusion, the clip arm may in particular have one or more grooves which may preferably extend substantially along the height direction H. In a cross-section of the clip arm, with a sectional plane which extends substantially in the longitudinal direction and in the width direction, the clip arm may, at least in sections, be formed approximately in a W-shape.

As a result, the clip arm can advantageously be stiffened in the width direction B. Furthermore, by avoiding material accumulations in the cross-section of the clip arm, the clip arm may advantageously be formed precisely, and in particular substantially without distortion, for example by injection molding. The clip arm of the fastening means 26 may in particular be manufactured in one piece with the lower plug connector housing part 20, for example by injection molding.

As a result, assembly of the flat plug connector 10 with repeat accuracy can advantageously be ensured, and in particular assembly of the multi-piece flat plug connector 10 can advantageously be ensured.

In preferred embodiments, the lower plug connector housing part 20 may have a recess 22 adjacent to the fastening means 26. As shown by way of example by FIGS. 4a, 4b, 19a and 19b, the recess 22 may in particular be adjacent to the fastening means 26 from the direction in which the protrusion of the clip arm extends from the clip arm. In other words, as shown by FIGS. 4a, 4b, 19a and 19b, the recess 22 may in particular be adjacent to the fastening means 26 in the direction in which the protrusion of the clip arm extends from the clip arm.

In the figures, the clip arm is shown by way of example with a protrusion extending substantially in parallel to the width direction B inwardly of the plug connector housing part 20, so that the recess 22 is arranged or formed at the plug connector housing part 20 in particular in parallel to the width direction B and inwardly of the plug connector housing part 20.

The recess 22 may have approximately the same extension in the longitudinal direction L as the fastening means 26, or preferably be larger than the extension of the fastening means 26 in the longitudinal direction L.

As a result, the flexibility of the fastening means 26 of the lower plug connector housing part 20 can advantageously be improved. Furthermore, in particular fatigue or damage at a root of the fastening means 26, in other words at a proximal end of the fastening means 26, can advantageously be prevented or reduced, whereby, in turn, the service life of the flat plug connector 10 and the flat plug connector system 1 can advantageously be improved.

The one or more fastening means 26 may in particular be arranged or formed at the upper step, in the height direction H, of the lower plug connector housing 20.

As a result, particularly firm fastening of the lower plug connector housing 20 to the upper plug connector housing 40 can advantageously be provided in a region in which the conductor portion 30 and/or the flat flexible conductor 110 is arranged between the lower and upper plug connector housings 20, 40. Furthermore, this can provide a particularly firm and secure clamping, in particular friction-fit clamping of the conductor portion 30 and/or the flat flexible conductor 110 between the lower and upper plug connector housings 20, 40, whereby, in turn, a good connection security for an electrically conductive connection of the flat plug connector system 1 can advantageously be ensured.

Additionally or alternatively, the one or more fastening means 26, which are arranged or formed in particular at the upper step, in the height direction H, of the lower plug connector housing, may advantageously provide a form-fit substantially opposite to the plugging direction S with a fixing portion 32 of the conductor portion 30 and/or the flat flexible conductor 110.

As a result, secure, in particular loss-proof, fastening of the conductor portion 30 and/or the flat flexible conductor 110 to the lower plug connector housing 20, as well as, for example, between the lower and the upper plug connector housings 20, 40 can further advantageously be provided.

As shown by way of example in FIGS. 4a and 19a, the step of the plug connector housing 11 spaced apart from the conductor portion 30, i.e. the upper plug connector housing part 40 or the lower plug connector housing part 20, and in particular on a side facing the conductor portion 30, may have one or more first stiffening ribs 25.

In particular, the lower plug connector housing part 20 may have one or more first stiffening ribs 25, in particular at the lower wall 24 thereof.

The one or more first stiffening ribs 25 may have a main extension which is substantially parallel to the longitudinal direction L and the height direction H.

The one or more first stiffening ribs 25 may in particular be arranged at an interface, or in other words at a transition, between the upper step, in the height direction H, and the lower step, in the height direction H, of the lower plug connector housing part 20. The one or more first stiffening ribs 25 may in particular extend on an upper side, in the height direction H, of the lower step or the lower wall 24.

The one or more first stiffening ribs 25 may in particular extend along only a part of the lower wall 24 of the lower plug connector housing part 20. In other words, the one or more first stiffening ribs 25 may extend adjacent to or starting from the upper step in the height direction H, in particular only partially in the longitudinal direction L along the lower wall 24.

By virtue of the first stiffening ribs 25, a material accumulation in the lower plug connector housing part 20 can advantageously be avoided. Furthermore, in particular a stiffener supporting the lower wall 24 may be provided, which improves the protection of the conductor portion 30 and/or the flat flexible conductor 110, in particular from below in the height direction H, while a coupling with the lower wall 52 of the complementary flat plug 50 is not impaired.

Alternatively or additionally, and as shown by way of example in FIGS. 6b and 21b, the lower plug connector housing part 20 may have one or more second stiffening ribs 27. The one or more second stiffening ribs 27 may have a main extension which is substantially parallel to the longitudinal direction L and the height direction H.

The one or more second stiffening ribs 27 may in particular be arranged at an interface, or in other words at a transition, between the upper step, in the height direction H, and the lower step, in the height direction H, of the lower plug connector housing part 20, but in particular substantially opposite the first one or more stiffening ribs 25. The one or more second stiffening ribs 27 may in particular extend on a lower side, in the height direction H, of the upper step.

The one or more second stiffening ribs 27 may in particular extend along the lower side, in the height direction H, of the upper step, in the height direction, of the lower plug connector housing part 20. In particular, the one or more second stiffening ribs 27 may extend substantially completely in the longitudinal direction L along the upper step in the height direction.

By virtue of the second stiffening ribs 27, a material accumulation in the lower plug connector housing part 20 can advantageously be prevented. Furthermore, in particular a stiffener supporting the lower wall 24 and the upper step in the height direction H may be provided, which improves the protection of the conductor portion 30 and/or the flat flexible conductor 110, in particular from below in the height direction H.

As illustrated by a comparison of FIG. 4a relating to the first embodiment of the flat plug connector system 1 with FIG. 19a relating to the second embodiment of the flat plug connector system 1, the lower plug connector housing 20 may be configured differently depending on the embodiment.

As shown by way of example with reference to the figures of the first embodiment of the flat plug connector system 1, the lower plug connector housing 20 may in particular be configured with a substantially continuous upper step in the height direction H.

As a result, simple assembly with the conductor portion 30 and/or the flat flexible conductor 110 is advantageously enabled, and in particular a rest that supports in a planar manner for the conductor portion 30 and/or the flat flexible conductor 110 is provided.

As shown by way of example with reference to the figures of the second embodiment of the flat plug connector system 1, the lower plug connector housing 20 may in particular be configured with an upper step that is substantially discontinuous in the height direction H. For example, the upper step in the height direction H may have at least a first portion and a second portion which are interrupted, at least in sections, along the extension of the lower plug connector housing 20 along the width direction B. For example, the first and second portions of the upper step in the height direction H may be interrupted, at least in sections, by a lower step in the height direction H. The lower step in the height direction H may in particular be the lower step which is (approximately) at a level in the height direction H with the lower wall 24 of the lower plug connector housing part 20.

In other words, the upper step, in the height direction H, of the lower plug connector housing part 20, along the extension of the plug connector housing part 20 in the width direction B, may in particular comprise an interruption in the height direction H. The interruption in the height direction H may in particular comprise a level lower in the height direction than the upper step in the height direction H. The interruption in the height direction H may in particular be arranged or formed centrally in the width direction B at the upper step in the height direction H.

As further shown with reference to the figures of the second embodiment of the flat plug connector system 1, the lower plug connector housing 20 may in particular be formed with a lower step interrupted at least in sections or a lower wall 24 interrupted at least in sections in the height direction H. For example, the lower wall 24 may have at least a first portion and a second portion which are interrupted, at least in sections, along the extension of the lower plug connector housing 20 along the width direction B. For example, the first and second portions of the lower wall 24 may be interrupted at least in sections, for example by an opening. The opening or interruption of the lower wall 24 may be arranged or formed in particular at a front end, in the plugging direction S of the flat plug connector 10, of the lower plug connector housing 20. The opening or interruption of the lower wall 24 may in particular be arranged or formed at the lower wall 24 centrally in the width direction B.

The lower plug connector housing part 20, as shown by way of example with reference to the figures of the second embodiment of the flat plug connector system 1, and as illustrated in particular by FIGS. 19a, 24a, 24b and 25a, advantageously allows to receive the coupling portion 14, which is arranged or formed at the upper plug connector housing part 40, at least in sections by the upper step in the height direction H formed in sections in the width direction B, and/or by the lower wall 24 formed in sections.

The lower plug connector housing part 20 may in particular be formed in one piece.

As a result, it is advantageously made possible to provide a particularly flat and (installation) space-saving flat plug connector system 1 which is in particular dimensionally stable and manufacturable with repeat accuracy and is in particular suitable for use in motor vehicles, such as cars, for example.

The upper plug connector housing part 40 of the flat plug connector 10, as shown in particular in FIGS. 5a, 5b, 20a and 20b, has in particular a coupling portion 14 which is configured for coupling to a complementary coupling portion 54 of the complementary flat plug connector 50 of the plug connector system 1, as shown in the other figures.

The form-fit of the coupling portion 14 with the complementary coupling portion 54, that is in principle in particular configured to be detachable, may be configured as a form-fit that is non-detachable, in particular not detachable in a non-destructive manner, in particular by a securing position of the securing element 5.

Furthermore, the form-fit of the coupling portion 14 with the complementary coupling portion 54, which is in principle in particular configured to be detachable, may be configured as a form-fit that is detachable, in particular detachable in a non-destructive manner, in particular by a non-securing position of the securing element 5.

One of the coupling portion 14 and the complementary coupling portion 54 may be configured to be substantially rigid with respect to the coupling part. The other one of the coupling portion 14 and the complementary coupling portion 54 may be configured to be substantially restorable, in particular elastically restorable, with respect to the part complementary to the coupling part. In other words, the coupling portion 14 and the complementary coupling portion 54 may in particular be configured such that substantially only one of the coupling portion 14 and the complementary coupling portion 54 is deformed or is being deformed in a restorable manner during coupling.

At least one of the coupling portion 14 and the complementary coupling portion 54 may have one or more rear-engageable portions 8. Furthermore, at least one of the coupling portion 14 and the complementary coupling portion 54 may have one or more restorably rear-engaging elements 7, in particular one or more elastically restorably rear-engaging elements 7. A restorably rear-engaging element 7 of the one or more restorably rear-engaging elements 7 is in particular complementary to one or more of the one or more rear-engageable portions 8. For example, a restorably rear-engaging element 7 and a complementary rear-engageable portion 8 each have a protrusion to form a form-fit, in particular in the plugging direction S, S′, in the coupled state of the flat plug connector system 1.

As shown by way of example by the figures of the first embodiment of the flat plug connector system 1, the flat plug connector 10 may, for example, have one or more substantially rigid rear-engageable portions 8, and the complementary flat plug connector 50 may correspondingly have one or more substantially elastically restorable rear-engaging elements 7 which are couplable to the rear-engageable portion(s) 8.

As shown by way of example by the figures of the second embodiment of the flat plug connector system 1, the flat plug connector 10 may, for example, have one or more substantially elastically restorable rear-engaging elements 7, and the complementary flat plug connector 50 may correspondingly have one or more substantially rigid rear-engageable portions 8 which are couplable to the restorably rear-engaging element(s) 7.

This advantageously allows to ensure an assembly operation with repeat accuracy.

At least one of the flat plug connector 10 and the complementary flat plug connector 50 may have a receptacle 12 for the securing element 5, for securing the coupled state of the flat plug connector system 1.

As shown by way of example by the figures of the first and second embodiments of the flat plug connector system 1, the receptacle 12 for the securing element 5 may be arranged in particular in the region of the coupling portion 14 or at the coupling portion 14.

The receptacle 12 is formed in particular by a region of the upper plug connector housing 40, and in particular by a region of the coupling portion 14. The receptacle 12 has in particular a guide for moving the securing element 5 between a non-securing position and a securing position. The guide for movement may in particular be a translational guide, i.e. a guide which substantially only allows a translational movement of the securing element 5 between the securing position and the non-securing position. For this purpose, the guide may, for example, form a form-fit transverse to the translational movement direction of the securing element 5.

The receptacle 12 may in particular be formed in one piece with the upper plug connector housing part 40.

The receptacle 12 has in particular one or more latches 45 which, in a non-coupled state of the flat plug connector system 1, i.e. in a state in which the coupling portion 14 and the complementary coupling portion 54 are not coupled to each other, may engage with one or more latch protrusions 82 of the securing element 5, in particular may engage in a form-fit manner.

The receptacle 12 may be configured to be rigid. The receptacle 12 may in particular be configured to be rigid such that the receptacle 12:
when arranging the securing element 5 at the receptacle 12,
when coupling the flat plug connector 10 to the complementary flat plug connector 50, in particular in a state in which the securing element 5 is arranged at the receptacle 12, and/or
when transferring the securing element 5 to the securing state, i.e. when the flat plug connector 10 and the complementary flat plug connector 50 are in particular already coupled to each other, does not deform.

As a result, the flat plug connector 10 and the complementary flat plug connector 50 may advantageously be configured to be rigid and durable, while the securing element 5, for example, may be configured as an easily replaceable element.

The one or more latches 45 may in particular be configured as openings or abutments which extend substantially in the width direction B and/or in the height direction H. The one or more latches 45 may thereby correspondingly provide an engagement or abutment for one or more latch protrusions 82 of the securing element 5, which in particular correspondingly extend substantially in the width direction B and/or in the height direction H.

In the coupled state of the flat plug connector system 1, i.e. in a state in which the coupling portion 14 and the complementary coupling portion 54 are coupled to each other, in particular are coupled to each other in a form-fit manner, one or more of the release elements 55 is configured to extend towards the one or more latch 45 such that the one or more latch protrusions 82 do not engage with the one or more latches 45.

A release element 55 of the one or more release elements 55 is in particular arranged or formed at that one of the coupling portion 14 and the complementary coupling portion 54 which does not have the receptacle 12.

The one or more release elements 55 may, for example, extend towards the one or more latches 45 such that an entry of the one or more latch protrusions 82 into the one or more latches 45 is blocked, and/or such that an engagement of the one or more latch protrusions 82 with the one or more latches 45 is detached.

Additionally or alternatively, the one or more release elements 55 may extend towards the one or more latches 45 such that the securing element 5, which is retained in the non-securing position, is (being) restorably deformed. In particular, a portion of the securing element 5 at which one or more of the latch protrusions 82 is arranged may be or become deformed restorably, in particular elastically restorably.

In exemplary embodiments, the one or more release elements 55 may be configured, in the coupled state, to be arranged between a portion of the receptacle 12 and a portion of the prong 86 in a manner elastically restorably deforming a prong 86 of the securing element 5.

In the coupled state of the flat plug connector system 1, in particular by means of the arrangement of the one or more release elements 55 in the coupled state, the securing element 5 is configured to be transferable from a non-securing position into a securing position. In particular, in the coupled state and by means of the arrangement of the one or more release elements 55, the securing element 5 is configured to be transferable between a non-securing position and the securing position of the securing element 5, in particular to be reversibly transferable in a non-destructive manner between a non-securing position and the securing position of the securing element 5. In other words, in the coupled state, the securing element 5 is in particular no longer retained in the non-securing position.

By virtue of the complementary configuration of the securing element 5 and the coupling portions 14, 54 of the flat plug connector 10 and the complementary flat plug connector 50, it can advantageously be ensured that the securing element 5 is retained in the non-securing position in the decoupled state and is transferable into the securing position only in the coupled state.

The receptacle 12 may have one or more counterhold abutments 48. A counterhold abutment 48 of the one or more counterhold abutments 48 is in particular configured to engage with a counterhold 88 of one or more counterholds 88 of the securing element 5. As illustrated in particular by FIG. 5a, the counterhold abutments 48 may be formed, for example, as webs or pillars of the receptacle 12, which extend, for example, at least in sections substantially in the height direction H. As illustrated in particular by FIG. 20a, the counterhold abutments 48 may be configured, for example, as protrusions of the receptacle 12, which extend, for example, at least in sections substantially in the width direction B. The one or more counterhold abutments 48 may, for example, have a face or a setback against or into which one or counterholds 88 of the securing element 5 may abut or engage. The face may, for example, extend substantially in parallel to the height direction H and/or in the width direction. The setback may in particular be a setback substantially in the height direction H or in the width direction B.

A counterhold 88 of the one or more counterholds 88 of the securing element 5 may in particular be configured as a protrusion which protrudes substantially in the height direction H and/or in the width direction B from the securing element 5. The counterhold 88 may in particular protrude in a direction which does not correspond to the direction in which the one or more latch protrusions 45 protrude.

A counterhold abutment 48 of the one or more counterhold abutments 48 may form a form-fit, for example a stop or an engagement, with one or more of the one or more counterholds 88, which prevents the securing element 5 from being detached from the receptacle 12, in particular substantially opposite to the plugging direction S. The counterhold abutments 48 may, for example, be configured as webs or pillars of the receptacle 12.

The one or more counterhold abutments 48 in cooperation with the one or more counterholds 88, together with the one or more latch 45 in cooperation with the one or more latch protrusions 82, may advantageously ensure the retention of the securing element 5 to the receptacle in the non-securing position. As a result, the securing element 5 can advantageously be pre-assembled to the receptacle 12, and the assembly of the flat plug connector system 1 can be simplified.

The receptacle 12 may advantageously provide a form-fit receptacle for the securing element 5, to which the securing element 5 is retained in a form-fit manner, in particular in a form-fit manner in the decoupled state of the flat plug connector system 1. The securing element 5 may in particular be received and retained in the receptacle 12 in a form-fit manner at least in sections, in particular in the non-securing position.

The upper plug connector housing part 40 has in particular fastening receptacles 46 complementary to the fastening means 26 of the lower plug connector housing part 20. As illustrated by way of example in FIGS. 5a, 5b, 20a and 20b, the fastening receptacles 46 may in particular be configured as a groove or recess at the upper plug connector housing part 40, for example as a groove or recess having a setback. The fastening receptacles 46 may in particular be arranged substantially opposite one another in the width direction B at the upper plug connector housing part 40. The fastening receptacles 46 may in particular be arranged or formed at ends of the upper plug connector housing part 40 substantially opposite one another in the width direction B.

The fastening receptacles 46 may in particular be arranged or formed at a rear portion, in the plugging direction S, of the upper plug connector housing part 40.

As a result, fastening of the lower plug connector housing part 20 to the upper plug connector housing part 40 can advantageously be provided, which does not impair the coupling of the flat plug connector 10 to the complementary flat plug connector 50, and in particular does not detach, in particular does not detach in a non-destructive manner, even upon applying a load directed in or opposite to the plugging direction S.

The fastening receptacles 46, in particular in cooperation with the fastening means 26, which may also be arranged or formed at the respective other one of the lower and upper plug connector housing parts 20, 40, enable an advantageously secure, simple and protective sandwich-like reception of the conductor portion 30 and/or the flexible flat conductor 110 between the lower and upper plug connector housing parts 20, 40. In particular, clamping can be advantageously improved in a region in which the lower plug connector housing part 20, the conductor portion 30 and/or the flexible flat conductor 110, as well as the upper plug connector housing part 40, are directly adjacent to one another in the assembled state of the flat plug connector 10. Here, the aforementioned elements may in particular be adjacent to one another in the following order in a sandwich-like manner: lower plug connector housing part 20, conductor portion 30 and/or flexible flat conductor 110, and upper plug connector housing part 40.

The conductor portion 30 and/or the flexible flat conductor 110 may be received at least in a form-fit manner between the lower and upper plug connector housing parts 20, 40, in particular such that the conductor portion 30 and/or the flexible flat conductor 110 are prevented from being pulled out substantially in and/or opposite to the longitudinal direction or substantially in and/or opposite to the plugging direction S of the flat plug connector 10.

Alternatively or additionally, the conductor portion 30 and/or the flexible flat conductor 110 may be connected to the lower and/or the upper plug connector housing part 20, 40 in a material-fit manner, for example by means of an adhesive.

Further alternatively or additionally, the conductor portion 30 and/or the flexible flat conductor 110 may be connected to the lower and/or the upper plug connector housing part 20, 40 in a friction-fit manner, for example by clamping the conductor portion 30 and/or the flexible flat conductor 110 between the lower plug connector housing part 20 and the upper plug connector housing part 40.

In exemplary embodiments, the fastening means 26 may provide a fastening biased in the height direction H with the fastening receptacles 46.

As a result, a particularly friction-fit connection of the conductor portion 30 and/or the flexible flat conductor 110 with the lower and upper plug connector housing parts 20, 40 can advantageously be improved.

Or the setback of the counterhold abutment 48 may The engagement between as are configured in particular with The counterholds and/or the counterhold abutments 48 may be configured, for example, as webs or pillars of the receptacle 12.

As illustrated in particular by FIGS. 4a to 6b and 19a to 21b, the upper plug connector housing part 40 may have a side wall 42, in particular an angled side wall 42, in particular at opposite ends in the width direction B, respectively. The respective side wall 42 is in particular configured so as to provide protection for the conductor portion 30 and/or the flexible flat conductor 110 towards the outside in the width direction B. The respective angled side wall 42 is in particular angled so as to be angled inwardly in the width direction B at a front end, in the longitudinal direction L or in the plugging direction S, of the side wall 42.

The side wall 42 may in particular extend downwards substantially along the height direction H from an upper wall 44 of the plug connector housing 11. The side wall 42 may in particular be configured to delimit the lower plug connector housing part 20, at least in sections, outwardly in the width direction B.

The side wall 42 advantageously improves protection of the conductor portion 30 and/or the flexible flat conductor 110 in the width direction B. Furthermore, the side wall 42 advantageously allows, in particular by means of the angled portion, to improve a form-fit reception of the conductor portion 30 and/or the flexible flat conductor 110 at the plug connector housing 11, as well as to protect the conductor portion 30 and/or the flexible flat conductor 110 in the plugging direction S or in the longitudinal direction L from the front. Furthermore, the side wall 42, in particular by virtue of the angled portion, allows to facilitate assembly with the lower plug connector housing part 20, for example by the side wall 42 providing a guide for laying the upper plug connector housing part 40 onto the lower plug connector housing part 20, and vice versa.

The upper plug connector housing 40 may in particular have one or more guide elements 43, in particular one or more elastically restorable guide elements 43.

The plug connector housing 40 may in particular have at least one guide element 43 at opposite ends in the width direction B, respectively.

A guide element 43 of the one or more guide elements 43 may in particular have a main extension substantially in the longitudinal direction L or in the plugging direction S. A guide element 43 of the one or more guide elements 43 may in particular have a protrusion at a front end in the longitudinal direction L or in the plugging direction S, which in particular protrudes substantially perpendicular to the longitudinal direction L or the plugging direction S.

The one or more guide elements 43 are in particular configured to touch the complementary flat plug connector 50 when coupling the flat plug connector 10 to the complementary flat plug connector 50, in particular under an elastically restorable deformation of the one or more guide elements 43.

The complementary flat plug connector 50 or the plug connector housing 51 of the complementary flat plug connector 50 may, for example, each have an abutment, in particular an abutment groove and/or a guide receptacle 53 for at least one of the one or more guide elements 43. The abutment, in particular the abutment groove and/or guide receptacle 53 of the complementary flat plug connector 50 may in particular be arranged or formed outside the contact receptacles 56 in the width direction B.

As shown by way of example in FIGS. 7b, 22a and 25b, the abutment or the abutment groove and/or the guide receptacle 53 may in particular have a protrusion and/or setback with which a guide element 43 of the one or more guide elements 43 can engage, in particular engage in a form-fit manner.

The one or more abutment or abutment groove and/or guide receptacle 53 of the plug connector housing 51 of the complementary flat plug connector 50, together with the one or more guide elements 43, may in particular form a first biasing contact of the flat plug connector 10 with the complementary flat plug connector 50 when plugging or coupling along the plugging direction S, S′. This first biasing contact of course refers to a mutually complementary orientation of the flat plug connector 10 relative to the complementary flat plug connector 50, in which the flat plug connector 10 and the complementary flat plug connector 50 are pluggable or couplable to provide an electrically conductive connection, in the sense of a usual state of use of a flat plug connector system 1.

The one or more guide elements 43 may in particular each be arranged or formed at a front end, in the longitudinal direction L or in the plugging direction S, of the side wall 42.

The guide elements 43 thus advantageously simplify the assembly of the flat plug connector system 1. Furthermore, the guide elements 43 in particular integrally additionally allow to provide protection of the conductor portion 30 and/or the flexible flat conductor 110 in the width direction B, in particular on both sides in the width direction B.

As illustrated by way of example in particular by FIGS. 5b and 20b, the upper plug connector housing part 40 may have one or more collars 49, in particular at an underside of the upper wall 44 in the height direction H. The collar 49 of the one or more collars 49 protrudes substantially downwardly along the height direction H, in particular at an underside of the upper wall 44. A collar 49 of the one or more collars 49 may in particular be arranged or formed at a position corresponding to the fastening receptacle 46. In other words, the collar 49 may in particular provide or form an extension of the fastening receptacle 46 along the height direction H, beyond an underside of the upper wall 44.

In exemplary embodiments, the protrusion or extension beyond the underside of the upper wall 44 formed by the collar 49 may be smaller than a thickness of the conductor portion 30 and/or the flexible flat conductor 110 in the height direction H. As a result, a predetermined clamping force connecting the conductor portion 30 and/or the flexible flat conductor 110 to the plug connector housing 11 in a friction-fit manner can advantageously be ensured.

In other exemplary embodiments, the collar 49 may form a protrusion or extension beyond the underside of the upper wall 44, which substantially corresponds to the thickness of the conductor portion 30 and/or the flexible flat conductor 110, or which is greater than a thickness of the conductor portion 30 and/or the flexible flat conductor 110. As a result, a clamping force that may deform or damage the conductors of the conductor portion 30 and/or the flexible flat conductor 110 can advantageously be avoided. Furthermore, a defined stop between the lower and upper plug connector housing parts 20, 40 can advantageously be ensured. This, in turn, allows to ensure a predetermined overall height of the flat plug connector 10, for example for coupling to the complementary flat plug connector 50.

The collar 49 is in particular configured to provide an edge of the fixing portion 32 of the conductor portion 30 and/or the flexible flat conductor 110, in particular opposite to the plugging direction S or opposite to the longitudinal direction L.

The collar 49 therefore advantageously enables, in particular together with the side wall 42, a form-fit arrangement or reception of the conductor portion 30 and/or the flexible flat conductor 110, in particular of the fixing portion 32, in particular both in the plugging direction S or in the longitudinal direction L, and opposite to the plugging direction S or the longitudinal direction L.

The collar 49 therefore advantageously improves the assembly capability of the flat plug connector 10, for example by facilitating laying of the upper plug connector housing part 40 onto the conductor portion 30 and/or the flexible flat conductor or vice versa. In order to lay the upper plug connector housing part 40 onto the conductor portion 30 and/or the flexible flat conductor 110, or vice versa, the conductor portion 30 and/or the flexible flat conductor 110 may already be laid onto or into the lower plug connector housing part 20. In further exemplary embodiments, however, the conductor portion 30 and/or the flexible flat conductor 110 may also be laid first onto or into the upper plug connector housing part 40, and then, in particular immediately thereafter, the lower plug connector housing part 20 may be laid onto or into the upper plug connector housing part 40 to fix the conductor portion 30 and/or the flexible flat conductor 110 in a sandwich-like manner.

As illustrated in particular by FIGS. 5a, 5b, 20a and 20b, the upper wall 44 may be contoured on the upper side thereof in the height direction H, for example be configured to be step-shaped at least in sections, and/or be substantially planar on the underside thereof in the height direction H, in particular aside from the ends in the width direction B.

As a result, on the one hand, good protection and good abutment of the conductor portion 30 and/or the flexible flat conductor 110 from above in the height direction H can advantageously be provided, and on the other hand, a stiffness of the upper plug connector housing part 40 can be improved.

As shown in particular by FIGS. 5a and 5b, in the first embodiment of the flat plug connector system 1, the upper wall 44 may in particular be formed continuously, without a separation of the abutment surface for the conductor portion 30 and/or the flexible flat conductor 110 in the width direction B. As a result, a flat plug connector system 1 with a comparatively small overall width in the width direction B can advantageously be provided, which also enables simple assembly of the conductor portion 30 and/or the flexible flat conductor 110.

As shown in contrast, in particular by FIGS. 20a and 20b, in the second embodiment of the flat plug connector system 1, the upper wall 44 may be formed in particular in sections, with at least one separation of the abutment surfaces for the conductor portion 30 and/or the flexible flat conductor 110 in the width direction B. As a result, a coupling portion 14 can advantageously be provided in the region of the separation of the abutment surfaces for the conductor portion 30 and/or the flexible flat conductor 110, whereby a flat plug connector system 1 with a particularly low overall height in the height direction H can be provided.

The upper wall 44 and the lower wall 24 of the plug connector housing 11 of the flat plug connector 10 advantageously provide protection for the conductor portion 30 and/or the flexible flat conductor 110 in the height direction H. An opening, formed at a front side in the plugging direction S, between the upper wall 44 and the lower wall 24 may in particular have a height of less than about 5 mm, in particular in the range from about 2.5 mm to about 4.5 mm, for example of about 4 mm.

As a result, efficient touch protection for the conductor portion 30 and the conductor elements 34 thereof can advantageously be provided.

The upper plug connector housing part 40 may in particular be formed in one piece. The plug connector housing 11 of the flat plug connector 10 may be formed in multiple pieces, in particular in two pieces, i.e. from the lower plug connector housing part 20 and the upper plug connector housing part 40. As a result, simple manufacture and assembly of the plug connector housing 11 can advantageously be ensured.

As soon as the conductor portion 30 and/or the flexible flat conductor 110 is placed or inserted on or in the lower plug connector housing part 20 or on the upper plug connector housing part 40, the conductor portion 30 and/or the flexible flat conductor 110 is advantageously supported by the respective one of the lower or upper plug connector housing part 20, 40 abutting, and protected at least on one side in the height direction H. Furthermore, this advantageously further enables assembly with the lower or upper plug connector housing part 20, 40 not yet abutting.

As soon as the conductor portion 30 and/or the flexible flat conductor 110 is arranged or inserted, at least in sections, between the lower and upper plug connector housing parts 20, 40, the conductor portion 30 and/or the flexible flat conductor 110 can advantageously be supported and protected at least on both sides in the height direction H.

If the lower and upper plug connector housing parts 20, 40 are fastened to each other and in particular the conductor portion 30 and/or the flexible flat conductor 110 is arranged therebetween, the flat plug connector 10 is in particular in an assembled state.

In the assembled state of the flat plug connector 10, the conductor portion 30 and/or the flexible flat conductor 110 abuts against a lower side, in the height direction H, of the upper wall 44, in particular in a flush manner.

Additionally or alternatively, in the assembled state of the flat plug connector 10, the conductor portion 30 and/or the flexible flat conductor 110 abuts against the main body 23 of the lower plug connector housing part 20, in particular against an upper side, in the height direction H, of the upper step of the plug connector housing part 20, in particular in a flush manner.

Further additionally or alternatively, in the assembled state of the flat plug connector 10, the conductor portion 30 and/or the flexible flat conductor 110 is in particular spaced apart from the lower wall 24 of the plug connector housing 11 of the flat plug connector 10, in particular spaced apart substantially in the height direction H.

By arranging the conductor portion 30 and/or the flexible flat conductor 110 at the flat plug connector 10 as described herein, the conductor portion 30 and/or the flexible flat conductor 110 can advantageously be protected at least on both sides in the height direction H. Furthermore, in particular the conductor portion 30 and the conductor elements 34 thereof can be supported upon contacting with the contacts 70 of the complementary flat plug connector 50, wherein the contacts 70 are in particular elastically restorably deformed at least in sections, in particular elastically restorably deformed substantially in the height direction H.

In FIGS. 2b and 15a and FIGS. 17b, 30a and 30b, an exemplary securing element 5 is shown, respectively. The securing element 5 shown as an example in FIGS. 2b and 15a is configured in particular for the first embodiment of the plug connector system 1. The securing element 5 shown as an example in FIGS. 17b, 30a and 30b is configured in particular for the second embodiment of the plug connector system 1.

As illustrated in particular by FIGS. 2b, 15a, 17b, 30a and 30b, as well as the other figures in which the securing element 5 is shown at least in sections, the securing element 5 may in particular have one or more latch protrusions 82 which are configured to engage with or abut against one or more latches 45 of the flat plug connector 10 at which the receptacle 12 is formed. As a result, the securing element 5 can be retained to the receptacle 12, in particular in the non-securing position. In particular, the securing element 5 can be retained to the receptacle 12 substantially in the plugging direction S or in the longitudinal direction L when the flat plug connector system 1 is in the non-coupled or decoupled state.

Additionally or alternatively, the securing element 5 may in particular have one or more counterholds 88 which are configured to engage with or abut against one or more counterhold abutments 48 of the flat plug connector 10 at which the receptacle 12 is formed. As a result, the securing element 5 can be retained to the receptacle, in particular in the non-securing position. In particular, the securing element 5 can be retained to the receptacle 12 substantially opposite to the plugging direction S or the longitudinal direction L, in particular regardless of whether the flat plug connector system 1 is in the coupled or non-coupled state.

The latch protrusion(s) 82 and/or the counterhold(s) 88 may each be configured in particular as a protrusion, in particular as a protrusion which protrudes from a prong 86 of the securing element 5 extending substantially in the plugging direction S or in the longitudinal direction L.

A latch protrusion 82 of the one or more latch protrusions 82 may in particular protrude in a different direction than a counterhold 88 of the one or more counterholds 88. The one or more latch protrusions 82 may, for example, protrude substantially in the height direction H. The one or more counterholds 88 may protrude substantially in the width direction B, for example.

In alternative embodiments, the latch protrusions 82 may protrude substantially in the width direction B, for example, and/or the counterholds 88 may protrude substantially in the height direction H, for example.

By virtue of the latch protrusions 82 and counterholds 88, that in particular extend in different ways, the securing element 5 is advantageously retainable to the receptacle 12, in particular retainable on both sides along the plugging direction S or the longitudinal direction L. In addition, the respective retentions in a predetermined direction, which secure the securing element 5 in each case with a predetermined retention force, can advantageously be defined independently of one another.

The securing element 5 has in particular multiple prongs 85, 86, wherein each of the prongs 85, 86 may in particular have a main extension substantially in the plugging direction S or in the longitudinal direction L. The prongs 85, 86 each extend from the same main body of the securing element 5, and may accordingly be formed in particular in one piece with the other prongs 85, 86. The prongs 85, 86 are separated from one another, in particular substantially in the width direction B, or in other words are spaced apart substantially in the width direction B.

As a result, the securing element 5 advantageously ensures a functional separation of the prongs 85, 86 from one another, which in turn advantageously prevents undesirable fatigue and/or damage to the securing element 5 and the prongs 85, 86 thereof. As a result, a reversible transfer, in particular with repeat accuracy, of the securing element 5 to the various positions and states, such as, in particular, the securing position and non-securing position, can furthermore advantageously be ensured.

Between a first prong 86 of the securing element 5 and a second prong 86 of the securing element 5, at each of which in particular a latch protrusion 45 and a counterhold 88 may be arranged or formed, in particular a securing prong 85 may be arranged or formed.

The securing prong 85 has in particular a protrusion 87 which can engage with a securing protrusion 47, 57 of the flat plug connector 10 or the complementary flat plug connector 50. The protrusion 87 of the securing prong 85 may, without being limited thereto, in particular protrude substantially in the height direction H from the securing prong 85.

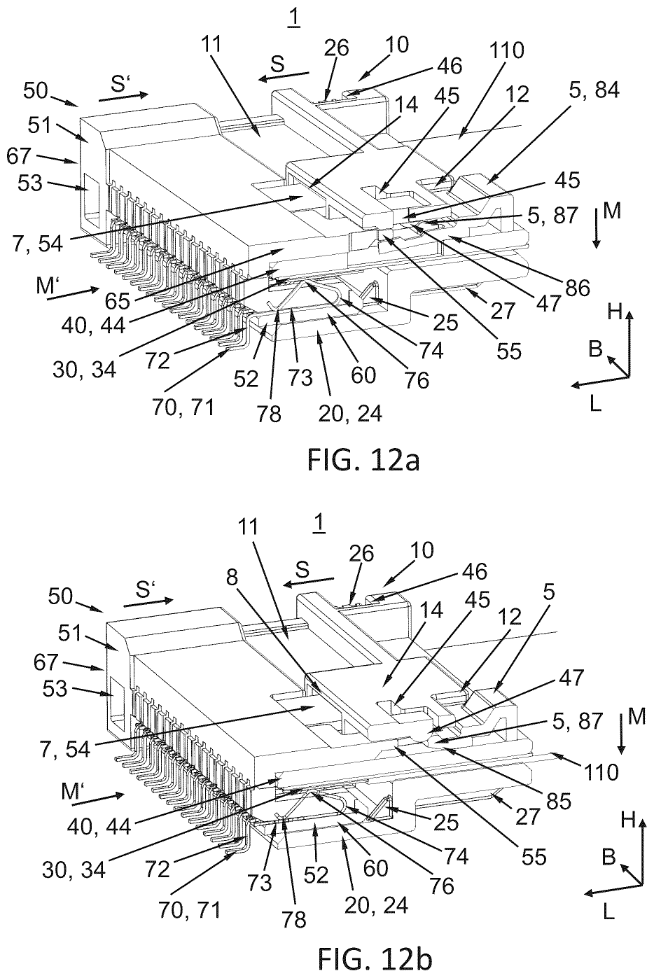

As illustrated by way of example by FIGS. 12b, 14b, 26a and 27b, the protrusion 87, in cooperation with the securing protrusion 47, 57, may in particular define a securing force for transferring the securing element 5 from the non-securing position into the securing position and/or a detaching force for transferring the securing element 5 from the securing position into the non-securing position.

The protrusion 87 of the securing prong 85 of the securing element 5 may in particular be formed along the plugging direction S or along the longitudinal direction L with a section-wise contour, in particular with a sectionally different contour facing the complementary securing protrusion 47, 57.

As illustrated by way of example in particular by FIGS. 15a, 30a and 30b, the protrusion 87 may, without being limited thereto, be formed in particular in an arcuate or semi-circular shape, wherein the arcuate shape or semi-circular shape extends at least partially constantly in the width direction B along the securing prong 85. In alternative embodiments, the protrusion 87 may be spherically shaped, for example, or shaped with a section-wise ramp shape or chamfer, for example.

The section-wise contour of the protrusion 87, in cooperation with the securing protrusion 47, 57, advantageously allows to define a securing force and a detaching force which are independent of one another.

If the protrusion 87, as shown by way of example in particular in FIGS. 15a, 30a and 30b, has a first contour portion with increasing extension in the height direction H, opposite to the plugging direction S or opposite to the longitudinal direction L, a transfer into the securing position can advantageously be defined with an increasing securing force and with a maximum securing force. As a result, an unintentional transfer of the securing element 5 into the securing position can furthermore advantageously be impeded or prevented.

If the protrusion 87, as shown by way of example in particular in FIGS. 15a, 30a and 30b, has a second contour portion with decreasing extension in the height direction H, in particular following the first contour portion opposite to the plugging direction S or opposite to the longitudinal direction L, a transfer into the securing position can advantageously be defined with a decreasing securing force from the point at which the maximum securing force is exceeded. The decreasing securing force may, for example, also be a securing force which is less than zero, so that the securing element 5 passively comes into the securing position after overcoming the maximum securing force.

By virtue of the securing operation described herein, in particular with a section-wise contour of the protrusion 87, haptic feedback when transferring the securing element into the securing position and into the non-securing position can advantageously be improved.

Alternatively or additionally, the securing protrusion 47, 57 of the flat plug connector 10 or the complementary flat plug connector 50, as shown by way of example in FIGS. 12a, 12b, 14a, 14b, 23a, 24a, 26a and 27b, may have a first contour portion which has an increasing extension along the height direction H in the plugging direction S or in the longitudinal direction L.

Further alternatively or additionally, the securing protrusion 47, 57 of the flat plug connector 10 or the complementary flat plug connector 50, as shown by way of example in FIGS. 12a, 12b, 14a, 14b, 23a, 24a, 26a and 27b, may have a second contour portion which has a decreasing extension along the height direction H in the plugging direction S or in the longitudinal direction L, in particular following the first contour portion.

The first contour portion of the securing protrusion 47, 57 advantageously allows to apply a predetermined, in particular elastically restorable deformation to the securing element 5, in particular the elastically restorable securing prong 85 of the securing element 5. The second contour portion of the securing protrusion 47, 57 advantageously allows to reduce the restorable deformation in a predetermined manner, in particular such that the securing element 5 passively reaches the securing position, substantially in the plugging direction S, without further application of a force to the securing element 5.

As a result, haptic and/or visual feedback when transferring the securing element 5 into the securing position and/or back into the non-securing position can be improved.

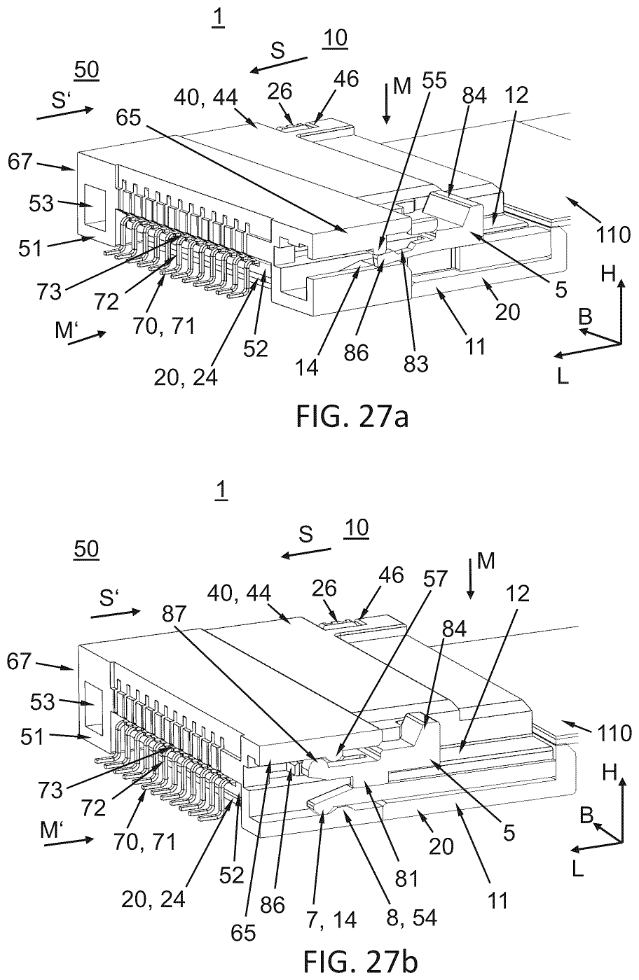

As illustrated in particular by FIG. 27b, in the second embodiment of the flat plug connector system 1, wherein the securing protrusion 57 is arranged or formed at the complementary flat plug connector 50, an increasing bias may advantageously be applied to the securing element 5 during a detaching relative movement of the flat plug connector 10 and the complementary flat plug connector 50, in particular opposite to the plugging direction S, S′. By virtue of the abutment against the restorably rear-engaging element 7, the securing element 5 is configured to hold the restorably rear-engaging element with a correspondingly increasing bias in the engagement at the rear-engageable portion 8.

As a result, an increasing force directed against detachment from the secured state can advantageously be passively provided, which in turn advantageously ensures a high connection security.

The securing element 5 may in particular have an actuating portion 84 at a rear end in the longitudinal direction L or in the plugging direction S. The actuating portion 84 may in particular be configured as a rear protrusion in the longitudinal direction L or in the plugging direction S, which protrudes substantially in the height direction H. The actuating portion 84 may in particular have a chamfer on a front side in the longitudinal direction L or in the plugging direction S, and/or in particular have a flat stop on a rear side in the longitudinal direction L or in the plugging direction S.

The actuating portion 84 advantageously enables simple actuation of the securing element 5, i.e. in particular simple application of a force to the securing element 5 in the plugging direction S, as well as simple gripping of the securing element 5 to move it opposite to the plugging direction S.

The securing element 5 may have a groove 83, in particular at a respective prong 86 at which at least one of the latch protrusion 45 and the counterhold 88 is also arranged.

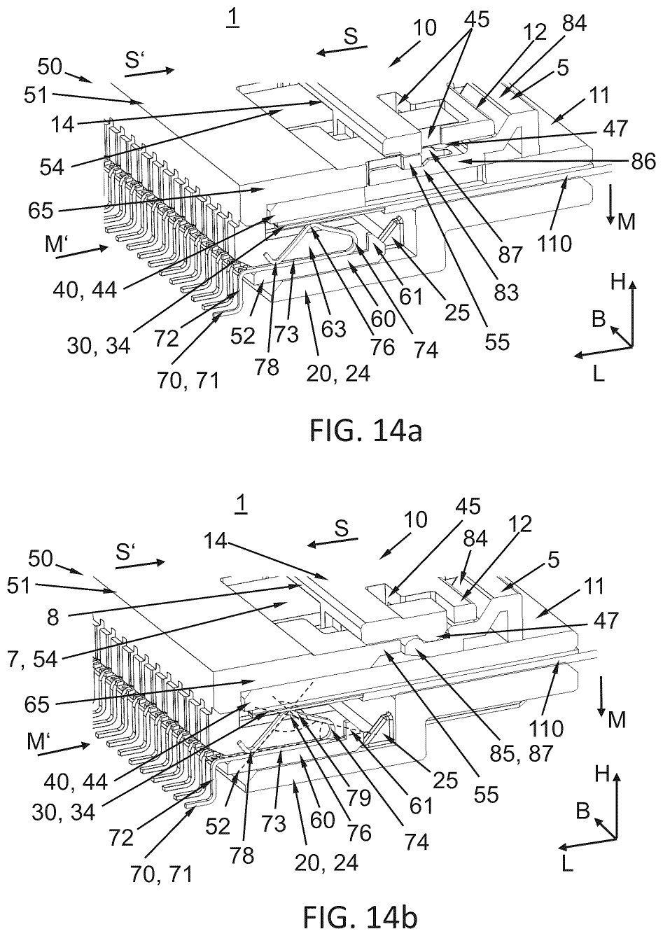

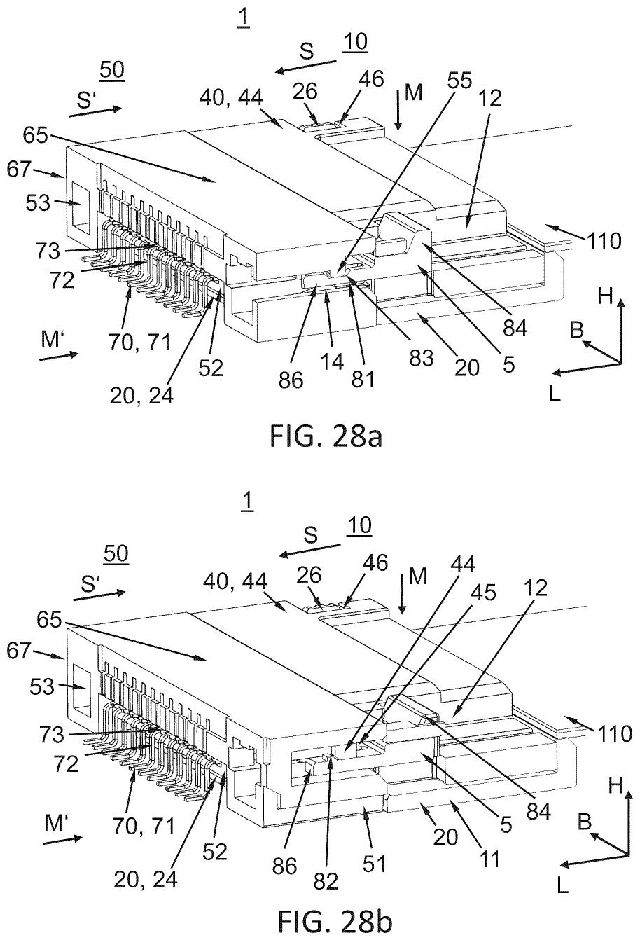

The groove 83 may in particular be configured to engage with one or more release elements 55 of the complementary flat plug connector 50 in a securing position of the securing element 5, as shown by way of example in particular in FIGS. 14a and 28a.

As a result, a deformation of the prongs 86, in particular one that is elastically restorable, can advantageously be reduced.

In exemplary embodiments, the groove 83 may have a section-wise contour along the longitudinal direction L or along the plugging direction S. The one or more grooves 83 may in particular cooperate with the one or more release elements 55 in such a way, in particular by a section-wise contour, as described analogously for the protrusion 87 and the complementary securing protrusion 47, 57.

The securing element 5 has in particular one or more securing surfaces 81, wherein the securing surfaces 81 are each configured, in the securing position, to bear against a restorably rear-engaging element 7 such that a restorable deformation of the restorably rear-engaging element 7 is impeded or blocked.

By means of the securing surfaces 81, the securing element 5 ensures in particular a non-detachable securing of a coupling between coupling portion 14 and complementary coupling portion 54, in particular a securing not detachable in a non-destructive manner.

As a result, the flat plug connector system 1 can advantageously be secured against detachment, while at the same time advantageously facilitating assembly of the flat plug connector system 1.

As illustrated in particular by FIG. 15a, the securing surface 81 may in particular have a main extension substantially in the plugging direction S or substantially in the longitudinal direction L, for example with an inclination with respect to the plugging direction S or the longitudinal direction L. The inclination may, for example, be in the range from about 5° to about 30°, in particular in the range from about 5° to about 20°. The inclination is in particular the angle which the securing surface 81 encloses with an imaginary line which substantially extends in the longitudinal direction L or in the plugging direction S, as viewed along the width direction B or in a sectional plane perpendicular to the width direction.

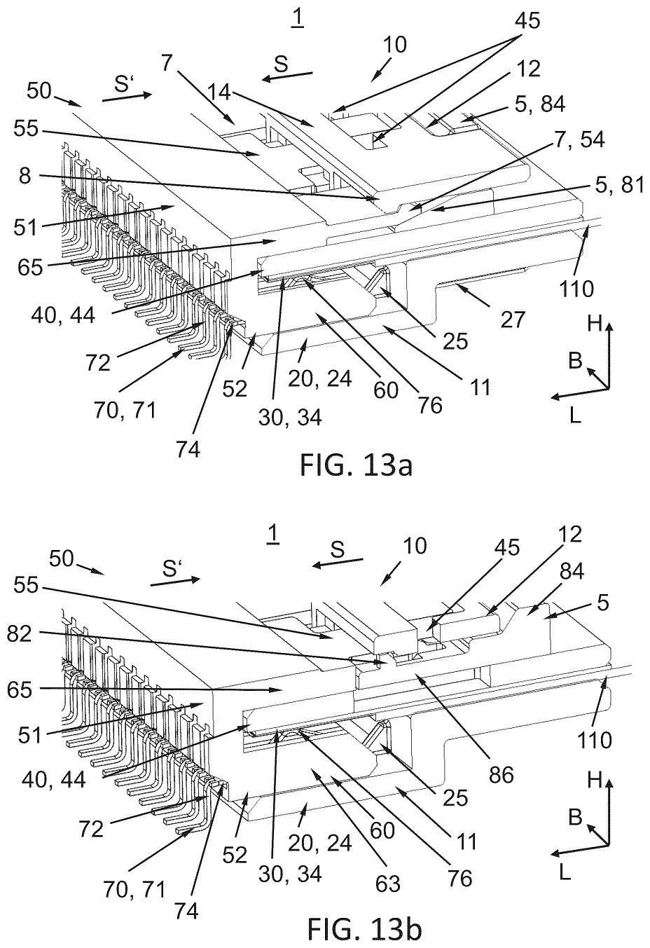

The inclination of the securing surface 81 advantageously enables, as illustrated by way of example by FIG. 13a, that a load distribution parallel to the height direction H and to the longitudinal direction L is ensured when the coupling portion 14 and the complementary coupling portion 54 attempt to detach from each other when the securing element 5 is in the securing position. As a result, a load can be advantageously distributed in a predetermined manner during detaching attempts in the secured state and in particular an improved service life of the flat plug connector system 1 can be ensured.

As illustrated in particular by FIG. 30b, the securing surface 81 may in particular have a main extension substantially in the plugging direction S or substantially in the longitudinal direction L, and may in particular be arranged or formed as a protrusion extending substantially in parallel to the height direction H on a lower side, in the height direction H, of the securing element 5.

The securing surface 81 thus advantageously enables a transfer guided in a rail-like manner, in particular translational transfer, between the non-securing and the securing position of the securing element 5. Integrally, the securing surface 81 allows to provide securing against a restorable deformation of the restorably rear-engaging element 7.

In FIGS. 15b and 15c and FIG. 30c, an exemplary contact 70 is shown, respectively. The contact 70 shown as an example in FIGS. 15b and 15c is configured in particular for the first embodiment of the plug connector system 1.

The contact 70 shown in FIG. 15b represents in particular a contact 70 in an undeflected posture or in an undeflected state. The contact 70 shown in FIG. 15b may therefore correspond in particular to the contact 70 as shown in FIG. 8b. Moreover, the contact 70 as shown in FIG. 15b may in particular also correspond to the respective contact 70 as shown in the other figures relating to the first embodiment of the flat plug connector system 1, in particular the figures which show a non-coupled state of the flat plug connector system 1.

The contact 70 shown in FIG. 15c represents in particular a contact 70 in a deflected posture or in a deflected state. The contact 70 shown in FIG. 15c may therefore correspond in particular to the contact 70 as shown in FIG. 14b. Moreover, the contact 70 as shown in FIG. 15c may in particular also correspond to the respective contact 70 as shown in the other figures relating to the first embodiment of the flat plug connector system 1, in particular the figures which show a coupled state of the flat plug connector system 1.

The contact 70 shown in FIG. 15c represents in particular a deflected state 70 of the contact 70 shown in FIG. 15b.

The contact 70 shown as an example in FIG. 30c is configured in particular for the second embodiment of the plug connector system 1. The contact 70 shown in FIG. 30c is shown in particular in the undeflected posture or in the undeflected state. The contact 70 shown in FIG. 30c may therefore correspond in particular to the contact 70 as shown in FIG. 23b. Moreover, the contact 70 as shown in FIG. 30c may in particular also correspond to the respective contact 70 as shown in the other figures relating to the second embodiment of the flat plug connector system 1, in particular the figures which show a non-coupled state of the flat plug connector system 1.

Even when the contact 70 in the figures relating to the second embodiment of the flat plug connector system 1 is not deflected or compressed in the height direction H in the coupled state of the flat plug connector system 1, it is to be understood that the contact 70 may in particular have a restoring deflection, in particular substantially analogous to the contact 70 of the first embodiment of the flat plug connector system 1.

As illustrated by way of example in particular by FIGS. 3b, 8b, 14b, 15b, 15c, 18b, 23b, 29 and 30c, as well as the other figures in which the contact 70 is shown at least in sections, the contact 70 has in particular a terminal portion 71.

In the assembled state of the complementary flat plug connector 50, the terminal portion 71 may in particular extend away from the plug connector housing 51 of the complementary flat plug connector 50, for example substantially in the longitudinal direction L and/or in the height direction H. The terminal portion 71 may in particular be a solderable portion. The terminal portion 71 is in particular configured to form an electrically conductive terminal to a printed circuit board (not shown) and/or to an electrical component (not shown).

The terminal portion 71 may, for example, have an extension in the range from about 0.5 mm to about 1.5 mm. The terminal portion 71 may in particular form a first end of the contact 70.

The contact 70 may further in particular have a retaining portion 73 which is configured, for example, for form-fit, friction-fit and/or material-fit retention to a contact receptacle 56 of the plug connector housing 51. The retaining portion 73 may, for example, have one or more protrusions which, for example, protrude substantially in the width direction B and/or in the height direction H from the contact 70.

The retaining portion 73 may, for example, be pushed, or in other words pressed, into the contact receptacle 56. In other words, in exemplary embodiments, the retaining portion 73 and the contact receptacle 56 may form a press-fit or an interference fit.

Alternatively or additionally, the contact receptacle 56 may have one or more recesses complementary to the protrusions of the retaining portion 73.

The retaining portion 73 may in particular have an increased width in the width direction B and/or an increased thickness in the height direction H with respect to the remaining contact 70. The retaining portion 73 may, for example, have a width in the width direction B in the range from about 0.35 mm to about 0.7 mm at least in sections, and in particular may have a width in the width direction B in the range from about 0.5 mm to about 0.6 mm at least in sections. In contrast, in exemplary embodiments, the contact 70 may, for example, have a width in the width direction B in the range from about 0.2 mm to about 0.3 mm. The contact 70 may in particular have a thickness in the range from about 0.1 mm to about 0.2 mm.

A contact receptacle 56 of the multiple contact receptacles 56 of the plug connector housing 51 may, for example, substantially have a width in the width direction B in the range from about 0.25 mm to about 0.4 mm, in particular in the range from about 0.3 mm to about 0.35 mm.

The retaining portion 73 may in particular have a main extension which is substantially parallel to the plugging direction S′ of the complementary flat plug connector 50.

The retaining portion 73 advantageously enables a firm retention to the plug connector housing 51 of the complementary flat plug connector 50, and in particular to a contact receptacle 56 of the plug connector housing 51.

At a front end of the contact 70 in the plugging direction S′ of the complementary flat plug connector 50 or at an end of the contact 70 opposite the longitudinal direction L, the contact 70 has in particular a bent portion 74.

The bent portion 74 extends in particular between the retaining portion 73 and a bent contact region 76 of the contact 70, wherein the bent contact region 76 is in particular configured to electrically conductively contact a conductor element 34 of the conductor portion 30, in particular in the coupled state of the flat plug connector system 1.

The angles of the respective portions of the contact 70 described herein and in particular below are illustrated by way of example by the dashed lines in FIGS. 8b, 14b, 15b, 15c, 23b, 29 and 30c, which in bent form represent the respective angle of the respective portion of the contact 70, and in rectilinear form represent in each case the edges of the contact 70 adjacent to the respective angle.

The bent portion 74 encloses in particular an acute angle, i.e. an angle of less than 90°. The bent portion 74 may in particular form a foremost portion, in the plugging direction S′, of the contact 70. As a result, the contact 70 can be advantageously configured to be elastically restorable, wherein in particular the bent portion 74 deforms towards a smaller angle, i.e. an even more acute angle, than in an uncoupled state of the flat plug connector system 1 upon electrically conductive contacting with a conductor element 34. The bent portion 74 may, in particular on a side facing away from the plugging direction S′, in particular form a smaller angle in a deflected posture than in an undeflected posture.

In an undeflected posture, i.e. in an uncoupled state of the flat plug connector system 1, the bent portion 74 may, for example, enclose an angle in the range from about 10° to about 30°, in particular enclose an angle in the range from about 13° to about 27°.

In a deflected posture, i.e. in a coupled state of the flat plug connector system 1, the bent portion 74 may, for example, enclose an angle in the range from about 5° to about 25°, in particular enclose an angle in the range from about 8° to about 22°.

The bent contact region 76 may in particular form an uppermost portion, in the height direction H, of the contact 70. The bent contact region 76 may in particular be a portion of the contact 70 that is exposed in the height direction H. The bent contact region 76 may in particular be exposed upwards in the height direction H relative to a first portion 75 adjacent at the front in the plugging direction S′, and/or relative to a second portion 77 adjacent to the bent contact region 76 at the rear in the plugging direction S′.

The bent contact region 76 can advantageously reliably ensure electrically conductive contacting with a conductor element 34, wherein the contact is made in particular in a soft, restoring manner. As a result, in turn, the service life of the conductor elements 34 and the contacts 70 can advantageously be improved.

The bent contact region 76 may have an obtuse angle, i.e. an angle of more than 90°, in particular on a side which faces the retaining portion 73 of the contact 70. In a deflected posture, the bent contact region 76 may, in particular on a side facing the retaining portion 73, in particular enclose a larger angle than in an undeflected posture.

In an undeflected posture, i.e. in an uncoupled state of the flat plug connector system 1, the bent contact region 76 may, for example, enclose an angle in the range from about 95° to about 135°, in particular enclose an angle in the range from about 100° to about 130°.

In a deflected posture, i.e. in a coupled state of the flat plug connector system 1, the bent contact region 76 may, for example, enclose an angle in the range from about 110° to about 145°, in particular enclose an angle in the range from about 115° to about 140°.

The bent contact region 76 advantageously enables safe and at the same time electrically conductive contacting that is gentle on both the contact 70 and the conductor element 34, whereby the respective service life and that of the flat plug connector system 1 is advantageously improved.

On a side of the bent contact region 76 which faces away from the bent portion 74 the contact 70 has in particular a support portion 78.

The support portion 78 may be arranged or formed at a substantially second end of the contact 70. The support portion 78 may in particular be bent, in particular such that the support portion 78 is substantially concave in shape on a side facing the retaining portion 73 in the height direction H.

In an undeflected posture, i.e. in an uncoupled state of the flat plug connector system 1, the support portion 78 may, for example, have a spacing, in particular substantially in the height direction H, with respect to the retaining portion 73, which is, for example, in the range from about 0.05 mm to about 0.15 mm, in particular in the range from about 0.08 mm to about 0.12 mm, in particular a spacing of about 0.1 mm.

The support portion 78 may have a greater spacing from the bent portion 74 than the bent contact region 76 has from the bent portion 74, in particular in the longitudinal direction L and/or in the plugging direction S of the flat plug connector system 1.

In a deflected posture, i.e. in a coupled state of the flat plug connector system 1, the support portion 78 may in particular be configured to contact the retaining portion 73, or in other words to be supported at the retaining portion 73.

The support portion 78 advantageously allows to ensure a predetermined contact force between the bent contact region 76 and the conductor element 34.

In conventional flat plug connectors, the contacts are in particular made of gold or gold-plated in particular, whereby sufficient electrically conductive contacting is ensured even with low contact forces.

In contrast, the present contact 70 advantageously enables a predetermined contact force to be ensured between the bent contact region 76 and the conductor element 34 by virtue of the elastically restorable deformation of the contact 70, wherein the support portion 78 adjacent to the bent contact region 76 is supported against the retaining portion 73.

This further makes it possible, for example, for the contact 70 to be tinned, i.e. in particular to be non-gold-plated or be configured without gold, without impairing the electrically conductive contacting. As a result, the contact 70 can, in turn, be advantageously manufactured inexpensively and can also be advantageously configured to be easily connectable to a printed circuit board and/or an electrical device, for example by means of soldering.

As shown by way of example in FIGS. 15b, 15c and 30c, a substantially rectilinearly extending or linearly extending second portion 77 may be formed between the bent contact region 76 and the support portion 78.

As a result, support of the bent contact region 76 by the support portion 78 can advantageously be stiffened, whereby a predetermined contact force can advantageously be ensured.

Alternatively or additionally, a substantially rectilinearly extending first portion 75 may be formed between the bent contact region 76 and the bent portion 74. The first portion 75 may in particular have a kink 79, wherein the tip of the kink 79 points in the height direction H towards the retaining portion 73. In other words, the first portion 75 may in particular have a kink 79 formed on a lower side, in the height direction H, of the first portion 75. The kink 79 may in particular enclose an obtuse angle, i.e. an angle of more than 90°, on an upper side in the height direction H. The kink 79 may in particular enclose an angle of more than about 100°, for example a value of about 105°, or in particular a value of more than about 105°, for example a value of about 108°, on an upper side in the height direction H.

The kink 79 may preferably be adjacent to the bent contact region 76.

The kink 79 advantageously allows to stiffen the bent contact region 76 and the bend thereof. As a result, a deflection of the contact 70 can advantageously be concentrated at the bent portion 74.

As a result, support of the bent contact region 76 by the support portion 78 can advantageously be stiffened, whereby a predetermined contact force can advantageously be ensured.

In particular, the bent contact region 76, the first portion 75 and the second portion 77 may form a contact portion of the contact 70 or be encompassed by it. The contact portion is in particular restorably deflectable. In the coupled state, the contact portion, and in particular the bent contact region 76 thereof, is in electrically conductive contact with the conductor portion 30, in particular with a conductor element 34 of the conductor portion 30, and optionally additionally, in particular physically, in direct contact.

In exemplary embodiments, the contact 70 may have a thickness build-up portion 72, in particular between the terminal portion 71 and the retaining portion 73. The thickness build-up portion 72 may in particular have a main extension which is substantially parallel to the height direction H.

The thickness build-up portion 72 in particular allows to form the terminal portion 71 at a level which substantially corresponds to a lowest level, in the height direction H, of the flat plug connector system 1. As a result, the terminal portion 71 of the contact 70 can be advantageously relieved when being attached to a printed circuit board and/or to an electrical device. As a result, in turn, the service life of the contacts 70, and accordingly the service life of the flat plug connector system 1, can advantageously be improved.

A contact 70 may in particular be formed in one piece, for example as a bending part.

As a result, the contact 70 is advantageously manufacturable inexpensively.

The contact 70 may comprise or consist of, for example, copper, a copper alloy, in particular bronze, nickel, nickel coated with gold, phosphorus nickel coated with gold flash, nickel coated with silver, nickel coated with tin, steel or another conductive material, without being limited thereto. Additionally or alternatively, the contact 70 may in particular be tinned. Further additionally or alternatively, the contact 70 may in particular be non-gold-plated or have no gold.

The plug connector housing 51 of the complementary flat plug connector 50 may, for example, comprise or consist of a polymer, in particular comprise or consist of a reflow solderable polymer. For example, the plug connector housing 51 may comprise or consist of polyether ether ketone (PEEK) and/or polyamide (PA). As a result, the plug connector housing 51 is advantageously manufacturable true to shape and, furthermore, the complementary flat plug connector 50 equipped with the assembled contacts 70 is connectable to a printed circuit board and/or an electrical device, in particular in a simple and reliable manner.

Starting from the non-coupled state, as illustrated for example by FIGS. 9a, 9b, 10a, 24a, 24b and 25a, the one or more latch protrusions 82 are engaged with or strike against the one or more latches 45. Furthermore, in particular the one or more counterholds 88 may be engaged with the counterhold abutments 48, or may be limited in a movement opposite to the plugging direction S.

During the coupling operation, in which the coupling portion 14 and the complementary coupling portion 54 come into mutual engagement, as illustrated by FIGS. 11a, 11b, 12a, 12b, 26a, 26b and 27a, the securing element 5 is deformed at least in sections, in particular such that the one or more latch protrusions 82 are no longer engaged with or strike against the one or more latches 45.

In particular, the one or more release elements 55 of the complementary flat plug connector 50 deflect at least one of the receptacle 12 and the securing element 5 accordingly, in particular in an elastically restorable manner.

Furthermore, as illustrated by FIGS. 12b and 26a, in particular a first contour portion of the protrusion 87 of the securing element 5 comes into contact with a first contour portion of the securing protrusion 47, 57, or to an adjacent position.

When securing, i.e. when transferring the securing element 5 into the securing position, wherein FIGS. 14a, 14b, 27b, 28a, 28b and 29 in particular represent the secured state, i.e. the securing position of the securing element 5, the elastic restoring of the securing element 5 is at least partially or completely reduced.

In particular, the securing element 5 is elastically restorably deformed in the region of the protrusion 87 when the first contour portions of the protrusion 87 and the securing protrusion 47, 57 slide off one another while applying the securing force. After overcoming a maximum deflection of the securing element 5 in the region of the protrusion 87 and/or the respective plug connector housing 11, 51 in the region of the securing protrusion 47, 57, further passing to the securing position may take place substantially passively, in particular by restoring the elastic deformations of the securing element 5.

In the secured state of the flat plug connector system 1, in particular the second contour portion of the securing protrusion 47, 57 and the second contour portion of the protrusion 87 of the securing element 5 face each other or are adjacent to one another. Additionally or alternatively, the one or more release elements 55 may be received, in particular at least in sections, in the grooves 83 of the securing element 5 such that the securing element 5 has in particular no or only a slight elastic deformation in the secured state.

As shown by way of example in FIGS. 13b and 28b, in the secured state, the one or more latch protrusions 82 may be arranged on a side of the receptacle 12 or the upper wall 44 facing away from the one or more latches 45. The surfaces of the latch protrusions 82 and the receptacle 12 or the upper wall 44 facing each other in the secured state may, for example, together with the securing protrusion 47, 57 and the protrusion 87 of the securing element 5, define an unsecuring force to transfer the securing element 5 from the securing position into the non-securing position.

As a result, a securing force can be further advantageously separated, in particular from a detaching force or unsecuring force, or in other words made independent.

The flowchart in FIG. 31 represents an exemplary method for securing a form-fit coupling between a flat plug connector 10 and a complementary flat plug connector 50. The method relates in particular to a flat plug connector 10 and/or a complementary flat plug connector 50, and in particular to a flat plug connector system 1, as shown in the other figures and described herein.

The flowchart in FIG. 31 describes in particular a method for securing a form-fit coupling between a flat plug connector 10 and a complementary flat plug connector 50, wherein the flat plug connector 10 has a coupling portion 14 and the complementary flat plug connector 50 has a complementary coupling portion 54 which is couplable to the coupling portion 14 in a form-fit manner.

The method comprises, but is not limited to, in particular the following steps, in particular in this order:
S10 arranging a securing element 5 at a receptacle 12 of one of the coupling portion 5 and the complementary coupling portion 54; and
S20 transferring the securing element 5 from a non-securing position towards a securing position at the receptacle 12, wherein the securing element 5 is configured to provide, in the securing position, a secured state of the coupling between the coupling portion 14 and the complementary coupling portion 54, in which detachment of the form-fit coupling between the coupling portion 14 and the complementary coupling portion 54 is prevented, wherein the coupling portion 14, the complementary coupling portion 54 and the securing element 5 are configured to be complementary to each other such that in a decoupled state in which the coupling portion 14 and the complementary coupling portion 54 are not coupled to each other, the securing element 5 is retained in the non-securing position.

The step S20 of transferring the securing element 5 into the securing position may in particular comprise applying a predetermined securing force, for example to transfer the securing element 5 into the securing position.

In exemplary embodiments, the receptacle 12 may comprise one or more latches 45 and/or the securing element 5 may comprise one or more latch protrusions 82 complementary to the one or more latches 45. The one or more latches 45 may in particular cooperate with the one or more latch protrusions 82 such that:
when a step of coupling the coupling portion 14 to the complementary coupling portion 54 in a form-fit manner is performed prior to transferring the securing element 5 into the securing position, the securing element 5 is transferable into the securing position, and
when a step of coupling the coupling portion 14 to the complementary coupling portion 54 in a form-fit manner is not performed prior to transferring the securing element 5 into the securing position, the one or more latch protrusions 82 are (being) engaged with the one or more latches 45 such that the securing element 5 is (being) retained in the non-securing position.

In exemplary embodiments, the step S20 of transferring the securing element 5 into the securing position may comprise moving the securing element 5 substantially in the plugging direction S.

In further exemplary embodiments, one of the coupling portion 14 and the complementary coupling portion 54 may comprise a securing protrusion 47, 57, and the securing element 5 comprises a protrusion 87 complementary to the securing protrusion 47, 57, wherein the securing protrusion 47, 57 and the complementary protrusion 87 of the securing element 5 in the secured state define a predetermined detaching force to be applied to transfer the securing element 5 from the securing position into a non-securing position.

The flowchart in FIG. 32 represents an exemplary method for manufacturing a flat plug connector 10. The method relates in particular to a flat plug connector 10, and in particular to a flat plug connector system 1, as shown in the other figures and described herein.

The flowchart in FIG. 32 describes in particular a method for manufacturing a flat plug connector 10.

The method comprises, but is not limited to, in particular the following steps, in particular in this order:
S110 providing a first upper plug connector housing part 40;
S120 providing a second lower plug connector housing part 20;
S130 arranging a conductor portion 30 with a flexible flat conductor 110 on or in the second lower plug connector housing part 20;
S140 arranging the first upper plug connector housing part 40 on the conductor portion 30 which is arranged on or in the second lower plug connector housing part 20; and
S150 fixing the first upper plug connector housing part 40 and the second upper plug connector housing part 20 to each other.

The method for manufacturing a flat plug connector 10 may further comprise in particular a step of providing a conductor portion 30 with a flexible flat conductor 110. This step is executable in particular prior to steps S130, S130′.

Steps S130, S140 and S150 are in particular executable in this exact order.

In further exemplary embodiments, the method may comprise the following steps, in particular in this order, in particular after steps S110 and S120:
S130′ arranging a conductor portion 30 with a flexible flat conductor 110 on or in one of the first upper plug connector housing part 40 and the second lower plug connector housing part 20;
S140′ arranging the other one of the first upper plug connector housing part 40 and the second lower plug connector housing part 20 on the conductor portion 30 which is arranged on or in the one of the first plug connector housing part 40 and the second lower plug connector housing part 20; and
S150 fixing the first upper plug connector housing part 40 and the second upper plug connector housing part 20 to each other.

It is to be understood that the elements designated above with the term complementary may also be designated without the term complementary, and in particular the element not designated with the term complementary represents the element complementary thereto.

### LIST OF REFERENCE NUMERALS

1 Flat plug connector system
5 Securing element
7 Restorably rear-engaging element
8 rear-engageable portion
10 Flat plug connector
11 Plug connector housing
12 Receptacle
14 Coupling portion
20 Lower plug connector housing part
22 Recess
23 Main body
24 Lower wall
25 First stiffening ribs
26 Fastening means
27 Second stiffening ribs
30 Conductor portion
32 Fixing portion
34 Conductor element
40 Upper plug connector housing part
42 Side wall
43 Guide element
44 Upper wall
45 Latch
46 Fastening receptacle
47 Securing protrusion
48 Counterhold abutment
49 Collar
50 Complementary flat plug connector
51 Plug connector housing
52 Lower wall
53 Guide receptacle
54 Complementary coupling portion
55 Release element
56 Contact receptacle
57 Securing protrusion
58 Fixing portion
59 Fixing means
60 Contact holder
61 Front wall
63 Support wall
65 Upper wall
67 Side wall
70 Contact
71 Terminal portion
72 Thickness build-up portion
73 Retaining portion
74 Bent portion
75 First portion
76 Bent contact region
77 Second portion
78 Support portion
79 Kink
81 Securing surface
82 Latch protrusion
83 Groove
84 Actuating portion
85 Securing prong
86 Prong
87 Protrusion
88 Counterhold
110 Flexible flat conductor
B Width direction
H Height direction
L Longitudinal direction
M, M′ Assembly direction
S, S′ Plugging direction
S10 to S20 Steps of a method for performing form-fit coupling
S110 to S150 Steps of a method for manufacturing a flat plug connector

1.-15. (canceled)

16. A contact for a flat plug connector,
wherein the contact has a terminal portion for electrically conductive connection to an electronic component;
wherein the contact has a retaining portion for fixing in a plug connector housing;
wherein the contact has a contact portion for electrically conductively contacting a complementary contact,
wherein the contact portion is connected to the retaining portion by means of a bent portion of the contact,
wherein the contact portion has a bent contact region for electrically conductively contacting a complementary contact,
wherein the contact portion has a first portion which is arranged between the bent contact region and the retaining portion, wherein the first portion and the retaining portion enclose an acute angle, and
wherein the contact portion has a second portion which is arranged opposite the first portion relative to the bent contact region, and wherein the second portion has a support portion which is configured to be supported at the retaining portion by the support portion upon deflection of the contact portion towards the retaining portion.

17. The contact according to claim 16, wherein the support portion limits the deflection of the contact portion such that a predetermined contact force is achieved.

18. The contact according to claim 17, wherein the predetermined contact force is in the range from about 0.5 N to about 2.0 N.

19. The contact according to claim 17, wherein the predetermined contact force is in the range from about 0.8 N to about 1.6 N.

20. The contact according to claim 16, wherein the bent contact region is exposed relative to the first portion and the second portion.

21. The contact according to claim 16, wherein a spacing between the support portion and the bent portion is greater than a spacing between the bent contact region and the bent portion.

22. The contact according to claim 16, wherein a ratio of a spacing between the support portion and the retaining portion relative to the spacing between the bent contact region and the retaining portion is in the range from about 3% to about 40%.

23. The contact according to claim 16, wherein a ratio of a spacing between the support portion and the retaining portion relative to the spacing between the bent contact region and the retaining portion is in the range from about 4% to about 30%.

24. The contact according to claim 16, wherein a ratio of a spacing between the support portion and the retaining portion relative to the spacing between the bent contact region and the retaining portion is in the range from about 5% to about 20%.

25. The contact according to claim 16, wherein the contact comprises a thickness build-up portion between the terminal portion and the retaining portion, wherein the thickness build-up portion extends such that the terminal portion and the retaining portion are spaced apart in a direction substantially perpendicular to the plugging direction of the flat plug connector.

26. The contact according to claim 16, wherein at least one of the first portion of the restorable contact portion and the second portion of the restorable contact portion extends substantially rectilinearly; and/or
wherein the restorable contact portion has a kink between the first portion and the bent contact region, wherein the kink encloses an obtuse angle on a side which faces away from the retaining portion; and/or
wherein the support portion of the second portion has a bend.

27. The contact according to claim 16, wherein the retaining portion has one or more protrusions for friction-fit and/or form-fit retention of the contact to the plug connector housing.

28. The contact according to claim 16, wherein the contact is tinned at least in sections.

29. The contact according to claim 16, wherein the contact is shaped in one piece.

30. The contact according to claim 16, wherein the contact is shaped in one piece and is a bending part.

31. A flat plug connector for a flat plug connector system,
wherein the flat plug connector comprises a plug connector housing, and
wherein at least one contact according to claim 16 is arranged at the plug connector housing.

32. The flat plug connector according to claim 31, wherein the plug connector housing has a plurality of contact receptacles for a corresponding plurality of contacts,
wherein each contact receptacle receives a retaining portion of a contact, and
wherein each contact receptacle is configured to laterally guide a support portion of a contact and/or a contact portion of a contact.

33. The flat plug connector according to claim 31, wherein the plug connector housing is shaped so as to surround the contact portion of the contact in a direction perpendicular to the plugging direction of the flat plug connector, and to additionally partially surround the contact portion on a side facing a complementary flat plug connector in the plugging direction of the flat plug connector.

34. The flat plug connector according to claim 31, wherein a plurality of contacts is arranged next to each other at the plug connector housing,
wherein the plurality of contacts is divided into at least two groups,
wherein the contacts of a first group of contacts are substantially evenly spaced apart from one another, wherein the contacts of a second group of contacts are substantially evenly spaced apart from one another, and wherein the groups are spaced apart from one another by a distance spacing which is greater than the contact spacing of the first group and greater than the contact spacing of the second group.
